(19) United States
(12) Patent Application Publication
(10) Pub. No.: US 2018/0157562 A1
(43) Pub. Date: Jun. 7, 2018

(54) VIRTUAL MACHINE-BASED DATA TRANSMISSION METHOD, APPARATUS AND SYSTEM

(71) Applicant: ALIBABA GROUP HOLDING LIMITED, Grand Cayman (KY)

(72) Inventors: Qi LI, Hangzhou (CN); Jian CHENG, Hangzhou (CN)

(21) Appl. No.: 15/887,829

(22) Filed: Feb. 2, 2018

Related U.S. Application Data
(63) Continuation of application No. PCT/CN2016/090823, filed on Jul. 21, 2016.

(30) Foreign Application Priority Data
Aug. 4, 2015 (CN) 201510472706.2

(51) Int. Cl. G06F 11/14; H04L 29/08; G06F 9/455

(52) U.S. Cl. CPC G06F 11/1484; H04L 67/2842; G06F 2009/45591; G06F 9/45508; G06F 2009/45595; G06F 9/45558

(57) ABSTRACT

The present application discloses a virtual machine-based data transmission method, apparatus and system. The method includes: generating, by a debug bridge executable program of a service terminal device, a debug bridge data packet; receiving, by a virtual host of the service terminal device, the debug bridge data packet through a pre-created virtual storage device; caching, by the virtual host, the debug bridge data packet to generate feedback information; and returning, by the virtual host, the feedback information to the debug bridge executable program, such that the debug bridge executable program sends a newly generated debug bridge data packet to the virtual host, wherein the debug bridge data packet is transmitted by the service terminal device to a target terminal device.

### CROSS REFERENCE TO RELATED APPLICATION

The disclosure claims the benefits of priority to International Application No. PCT/CN2016/090823, filed Jul. 21, 2016, which is based on and claims the benefits of priority to Chinese Application No. 201510472706.2, filed Aug. 4, 2015, both of which are incorporated herein by reference in their entireties.

### BACKGROUND

A storage device is a standard peripheral of a computer system. In more and more network systems, however, a remote system can be allowed to transparently use a storage device at a local end. For example, in a Virtual Desktop Infrastructure (VDI) system, when a local terminal logs onto a virtual desktop generated by a server of a data center through a network, a storage device accessing the local terminal cannot be directly used in the virtual desktop displayed on the local terminal. To provide better a user experience and meet the requirement of using a storage device accessing a local terminal in a VDI system, a storage device virtualization redirection method is designed and implemented such that a remote system can transparently use, through network transmission, a storage device inserted at a local end.

For example, by using the storage device accessed at the local end being an Android device as an example, the Android device may be used as a storage device to access the local end. With the widespread use of Android systems, a user may need to access or debug an Android device in a virtual desktop that the user logs onto. For example, the user can use computer software such as an Android phone assistant in the virtual desktop. However, to manage an Android phone by means of the computer software, it is necessary to use a debug bridge function of the Android phone, such as an Android Debug Bridge (ADB). The ADB function is used as an example below. FIG. 1 is an architectural diagram of ADB data transmission. As shown in FIG. 1, an ADB client runs on a computer terminal, and is used for generating an ADB service request packet after parsing a command input by a user and sending the request to an ADB server through a local socket. The ADB server also runs on the computer terminal. On one hand, the ADB server is responsible for parsing and replying to the service request of the ADB client. On the other hand, if the service request needs to be completed in coordination with an Android phone terminal, the ADB server initiates a service request to the Android phone terminal, encapsulates the service request into a transmission protocol packet, and interacts with the Android phone terminal through a USB interface. An ADB daemon process runs on the Android phone terminal, and is used for parsing the transmission protocol packet on the USB interface and responding to the service request initiated by the ADB server.

However, in the current storage device virtualization redirection method, the transmission rate in the debug bridge mode is generally at a Kilobyte (KB) level. At such a rate, many kinds of software such as the mobile phone assistant cannot be normally used in a remote system, which significantly restricts use of an Android phone in systems such as the virtual desktop.

No effective solution is currently put forward for the foregoing problem regarding the management efficiency of an Android device being low in a remote system due to a low transmission rate during storage device virtualization in a debug bridge mode.

### SUMMARY

Embodiments of the present application provide a virtual machine-based data transmission method, apparatus and system, so as to at least solve the technical problem in the prior art that management efficiency of an Android device is low in a remote system due to a low transmission rate during storage device virtualization in a debug bridge mode.

According to an aspect of embodiments of the present application, a virtual machine-based data transmission method is provided, including: generating, by a debug bridge executable program running in a service terminal device, a debug bridge data packet; receiving, by a virtual host running on the service terminal device, the debug bridge data packet through a pre-created virtual storage device; caching, by the virtual host, the debug bridge data packet, and generating feedback information; and returning, by the virtual host, the feedback information to the debug bridge executable program, such that the debug bridge executable program sends a newly generated debug bridge data packet to the virtual host, wherein the debug bridge data packet is transmitted by the service terminal device to a target terminal device.

According to another aspect of embodiments of the present application, a virtual machine-based data transmission method is further provided, including: receiving, by an intermediate terminal device installed with a virtual client, a debug bridge service data packet transmitted by a target terminal device, wherein the target terminal device generates the debug bridge service data packet by using a debug bridge daemon process, and transmits the debug bridge service data packet to the virtual client through a storage device; caching, by the virtual client, the debug bridge service data packet, and generating first feedback information; and returning, by the virtual client, the first feedback information to the debug bridge daemon process, and starting the debug bridge daemon process to send a newly generated debug bridge service data packet, wherein the debug bridge service data packet is transmitted by the intermediate terminal device to a service terminal device.

According to another aspect of embodiments of the present application, a virtual machine-based data transmission apparatus is further provided, including: a generation module configured to enable a debug bridge executable program running in a service terminal device to generate a debug bridge data packet; a first receiving module configured to enable a virtual host running on the service terminal device to receive the debug bridge data packet through a pre-created virtual storage device; a processing module configured to enable the virtual host to cache the debug bridge data packet and generate feedback information; and a first sending module configured to enable the virtual host to return the feedback information to the debug bridge executable program, such that the debug bridge executable program sends a newly generated debug bridge data packet to the virtual host, wherein the debug bridge data packet is transmitted by the service terminal device to a target terminal device.

According to another aspect of embodiments of the present application, a virtual machine-based data transmission apparatus is further provided, including: a receiving module configured to enable an intermediate terminal device installed with a virtual client to receive a debug bridge service data packet transmitted by a target terminal device, wherein the target terminal device generates the debug bridge service data packet by using a debug bridge daemon process, and transmits the debug bridge service data packet to the virtual client through a storage device; a processing module configured to enable the virtual client to cache the debug bridge service data packet and generate first feedback information; and a first sending module configured to enable the virtual client to return the first feedback information to the debug bridge daemon process and start the debug bridge daemon process to send a newly generated debug bridge service data packet, wherein the debug bridge service data packet is transmitted by the intermediate terminal device to a service terminal device.

According to another aspect of embodiments of the present application, a virtual machine-based data transmission system is further provided, including: a target terminal device; a service terminal device, which is installed with a debug bridge executable program and a virtual host and configured to: after the virtual host receives and caches a debug bridge data packet generated by the debug bridge executable program, convert the debug bridge data packet into a virtual data packet and generate feedback information, and meanwhile return the feedback information to the debug bridge executable program, such that the debug bridge executable program continues to send a newly generated debug bridge data packet to the virtual host; and an intermediate terminal device, which is installed with a virtual client, connected to the service terminal device through a network and connected to the target terminal device through a storage device, and configured to: receive a debug bridge reply data packet generated, according to the debug bridge data packet, by a debug bridge daemon process running on the target terminal device, wherein after the virtual client caches the debug bridge reply data packet and generates feedback reply information, the virtual client returns the feedback reply information to the debug bridge daemon process, such that the debug bridge daemon process continues to send a newly generated debug bridge reply data packet to the virtual client, wherein the service terminal device transmits the debug bridge data packet to the target terminal device through the intermediate terminal device, and the target terminal device also transmits the debug bridge reply data packet to the service terminal device through the intermediate terminal device.

In embodiments of the present application, an immediate feedback reply function is implemented in a virtual host added in a service terminal device to improve data transmission efficiency. First, the virtual host caches a debug bridge data packet locally upon receipt of the debug bridge data packet, and returns feedback information for the debug bridge data packet to a debug bridge executable program that runs on the service terminal device locally. After receiving the feedback information, the debug bridge executable program can determine that the currently sent debug bridge data packet has been sent successfully, and therefore sends a next debug bridge data packet, thus achieving an objective of improving debug bridge data packet sending efficiency of the debug bridge executable program, thereby implementing rapid downlink transmission of debug bridge data in the service terminal device to a target terminal device. The foregoing solution achieves a technical effect of improving a data exchange rate between the debug bridge executable program in a virtual desktop and a debug bridge daemon process in the target terminal device, thereby solving the technical problem in the prior art that management efficiency of an Android device is low in a remote system due to a low transmission rate during storage device virtualization in a debug bridge mode.

### BRIEF DESCRIPTION OF THE DRAWINGS

The accompanying drawings described herein are used to provide further understanding of the present application, and constitute a part of the present application. Schematic embodiments of the present application and description thereof are used to explain the present application, and do not constitute improper limitations to the present application.

FIG. 1 is an architectural diagram of ADB data transmission.

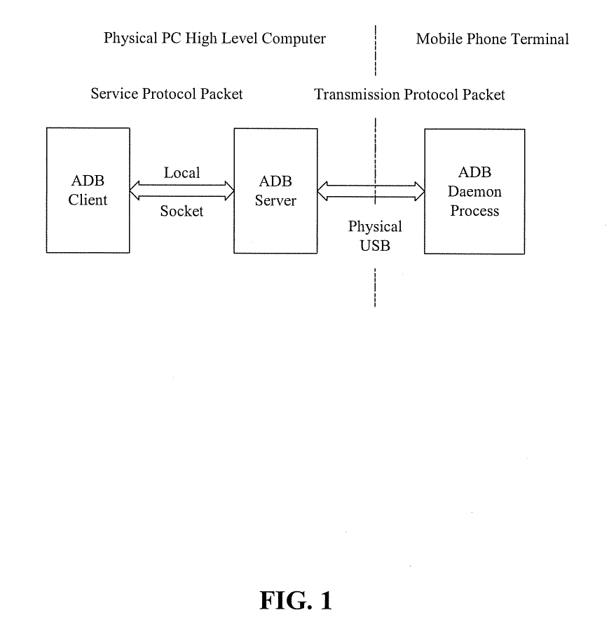

FIG. 2 is a hardware structural block diagram of a computer terminal for a virtual machine-based data transmission method according to embodiments of the present application.

FIG. 3 is a flowchart of a virtual machine-based data transmission method according to embodiments of the present application.

FIG. 4 is a schematic service flowchart of an exemplary user data access control method according to embodiments of the present application.

FIG. 5 is a flowchart of a virtual machine-based data transmission method according to embodiments of the present application.

FIG. 6 is a schematic structural diagram of a virtual machine-based data transmission apparatus according to embodiments of the present application.

FIG. 7 is a schematic structural diagram of an exemplary virtual machine-based data transmission apparatus according to embodiments of the present application.

FIG. 8 is a schematic structural diagram of an exemplary generation module according to embodiments of the present application.

FIG. 9 is a schematic structural diagram of another exemplary virtual machine-based data transmission apparatus according to embodiments of the present application.

FIG. 10 is a schematic structural diagram of a virtual machine-based data transmission apparatus according to embodiments of the present application.

FIG. 11 is a schematic structural diagram of an exemplary virtual machine-based data transmission apparatus according to embodiments of the present application.

FIG. 12 is a schematic structural diagram of another exemplary virtual machine-based data transmission apparatus according to embodiments of the present application.

FIG. 13 is a schematic structural diagram of a virtual machine-based data transmission system according to embodiments of the present application.

FIG. 14 is an implementation architectural diagram of an exemplary virtual machine-based data transmission system according to embodiments of the present application.

FIG. 15 is a structural block diagram of a computer terminal according to embodiments of the present application.

### DETAILED DESCRIPTION

To make those skilled in the art better understand the technical solutions of the present application, the technical solutions in embodiments of the present application will be described below with reference to the accompanying drawings in embodiments of the present application. It is apparent that embodiments described are merely some embodiments rather than all embodiments of the present application. Based on embodiments in the present application, all other embodiments obtained by those of ordinary skill in the art without making creative efforts should belong to the protection scope of the present application.

It should be noted that terms such as “first” and “second” used in the specification, claims, and foregoing accompanying drawings of the present application are used for distinguishing similar objects, and do not necessarily describe a particular order or sequence. It should be understood that data used in such a manner may be exchanged in proper situations, so that embodiments of the present application described here can be implemented in a sequence other than those shown or described here. In addition, the terms “include”, “comprise” or any other variations thereof are intended to cover non-exclusive inclusions, so that a process, method, system, product or device including a series of steps or units is not necessarily limited to the steps or units clearly listed, and may include other steps or units not clearly listed or other steps or units of the process, method, product or device.

A Virtual Desktop Infrastructure (VDI), by running a processing system in a server of a data center, implements a connection between a client device and a virtual desktop through a client computing protocol. A large quantity of independent desktop operating systems may be generated on the server of the data center. By logging on through network (e.g., the Ethernet), a user terminal can access its own desktop system anytime and anywhere.

A thin terminal or thin client is a terminal device widely used in current virtual desktop architectures, and refers to a computer terminal that basically does not need any application program in a client-server network system. The thin terminal communicates with a server through some protocols and thus accesses a local area network. The thin client transports inputs of a mouse, a keyboard, and the like to the server for processing. The server then returns the processing result to the client for displaying. Different clients may log onto the server at the same time to simulate independent working environments on the server. Unlike the thin terminal, an ordinary client may perform local data processing as much as possible, and only transmits necessary communication data during communication with the server or other clients.

A MicroPC is a system that implements PC-like functions by using an embedded terminal system.

A virtual machine-based data transmission method can be provided according to embodiments of the present application. It should be noted that, steps shown in the flowchart of the accompanying drawing may be performed in a computer system such as a set of computer executable instructions. In addition, although a logic sequence is shown in the flowchart, the steps shown or described may be performed in a sequence different from the sequence herein in some cases.

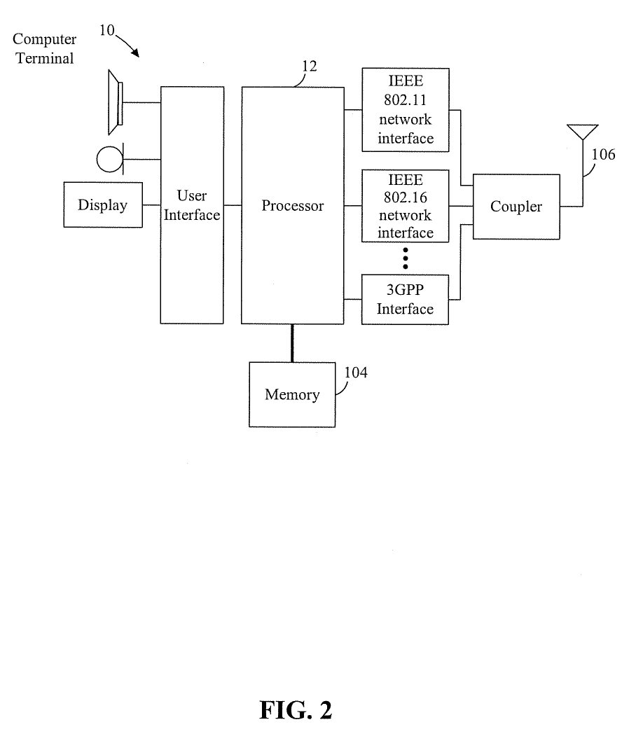

The virtual machine-based data transmission method of the present application may be performed in a mobile terminal, a computer terminal or a similar computation apparatus. By using running on a computer terminal as an example, FIG. 2 is a hardware structural block diagram of a computer terminal for a virtual machine-based data transmission method according to embodiments of the present application. As shown in FIG. 2, computer terminal 10 may include one or more (only one is shown in the figure) processors 102. Processor 102 may include, but is not limited to, a processing apparatus such as a micro processing unit (MCU) or a programmable logic device (FPGA). Computer terminal 10 may further include a memory 104 configured to store data, and a transmission module 106 configured for a communication function. It is appreciated that, the structure shown in FIG. 2 is merely an example and does not limit the structure of the foregoing electronic device. For example, computer terminal 10 may also include more or fewer components than those shown in FIG. 2, or has a configuration different from that shown in FIG. 2.

Memory 104 may be configured to store software programs of application software and modules, for example, program instructions/modules corresponding to the virtual machine-based data transmission method in embodiments of the present application. Processor 102 can perform various functional applications and data processing. For example, processor 102 can implement a vulnerability detection method of the foregoing application program, by running the software programs and modules stored in memory 104. Memory 104 may include a high-speed random access memory, and may further include a non-volatile memory, such as one or more magnetic storage apparatuses, a flash memory, or other non-volatile solid-state memories. In some examples, memory 104 may further include memories remotely set with respect to processor 102, and these remote memories may be connected to computer terminal 10 through a network. Examples of the network include, but are not limited to, the Internet, an intranet, a local area network, a mobile communications network or a combination thereof.

Transmission apparatus 106 can be configured to receive or send data through a network. Examples of the network may include a wireless network provided by a communication provider of computer terminal 10. In an example, transmission apparatus 106 includes a Network Interface Controller (NIC), which may be connected to another network device through a base station, thereby communicating with the Internet. In an example, transmission apparatus 106 may be a Radio Frequency (RF) module, which can be configured to communicate with the Internet in a wireless manner.

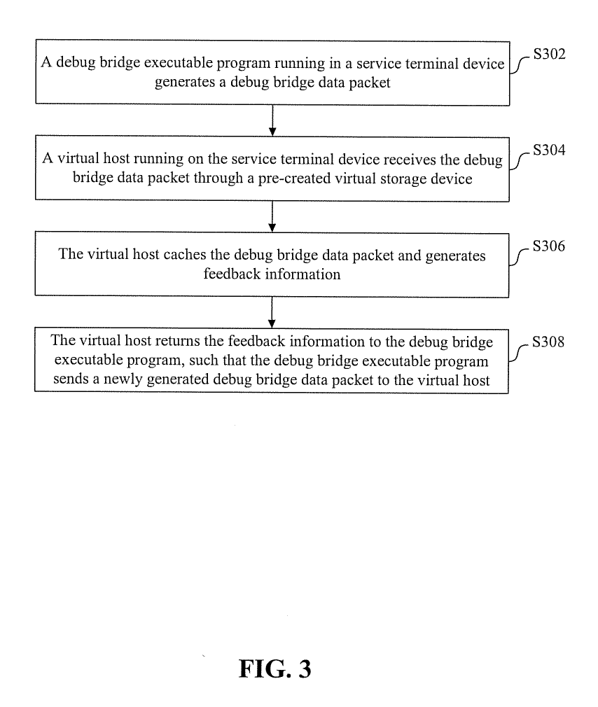

In the foregoing running environment, the present application provides a virtual machine-based data transmission method as shown in FIG. 3. FIG. 3 is a flowchart of a virtual machine-based data transmission method according to embodiments of the present application.

With reference to FIG. 2 and FIG. 3, computer terminal 10 may be a service terminal device installed with a virtual host. As shown in FIG. 3, an exemplary virtual machine-based data transmission method includes the following implementation steps S302-S308.

In step S302,: a debug bridge executable program running in a service terminal device generates a debug bridge data packet.

In step S302, the service terminal device can be a collective term for remote systems, such as, a server of a data center. A debug bridge may be a tool of the service terminal device for operating and managing a storage device. The debug bridge executable program may be a collective term for debug bridge-related processes running in the service tenninal device, and manifested as an EXE program in the service terminal device. The debug bridge data packet can be generated by the debug bridge executable program according to a stipulated protocol. The debug bridge executable program parses a command input by a user to generate a debug bridge service request, and encapsulates the debug bridge service request in the debug bridge data packet.

It is appreciated that, when a storage device accesses the service terminal device, the debug bridge executable program running in the service terminal device may send (directly or indirectly) the debug bridge data packet, in the form of a transmission protocol packet, to the storage device through a physical storage device interface. Through the physical storage device interface, data may be exchanged between the service terminal device and the storage device. However, when the service terminal device is a remote device, a physical storage device channel between the storage device and the service terminal device is replaced with a network channel, decreasing the data exchange rate between the service tenninal device and the storage device. For example, the service terminal device may send the debug bridge data packet, in the form of a transmission protocol packet, to the storage device through a network interface. The service terminal device does not send a next debug bridge data packet until reply information of the storage device is returned through the network. Such a transmission mode can cause a significant delay and low transmission efficiency.

In some embodiments, the debug bridge may be applied to an Android system and manifests as an Android Debug Bridge (ADB). The ADB may be used for functions such as development and debugging for the Android system, and is currently a main method for operating an Android phone by using mobile phone assistant software on a PC. As discussed above, the debug bridge executable program may be an ADB executable program running in the service terminal device, such as “ADB.exe”. Similarly, the debug bridge data packet may be an ADB data packet, and the stipulated protocol may be an ADB protocol. The ADB protocol can include a set of service protocols in an Android phone. And the set of service protocols can be transmitted through a storage device and used for debugging and management. In embodiments of the present application, the debug bridge can be applied to an Android system. However, the debug bridge may further have other specific application scenarios.

In some embodiments, when a MicroPC logs onto a virtual desktop and accesses an Android phone connected to the MicroPC, the MicroPC can be connected to the Internet in a wired or wireless manner, and the Android phone can be connected to the MicroPC through a storage device connecting wire, such as a USB connecting wire. The service terminal device is, for example, a server device set on a cloud server (e.g., Aliyun™). A user can log, through the MicroPC, onto a virtual desktop generated in the cloud server, and open a mobile phone assistant in the desktop to manage the Android phone connected to the MicroPC. According to an operation of the user, a debug bridge executable program, such as ADB.exe, running in the cloud server can generate an ADB service request, and encapsulate the service request to generate an ADB data packet.

In step S304, a virtual host running on the service terminal device receives the debug bridge data packet through a pre-created virtual storage device.

In step S304, in some embodiments, the virtual host runs in the service terminal device. The virtual host can be created in the service terminal device by means of virtualization based on a virtual machine technology. The virtual host may create a virtual storage device and manage the created virtual storage device. The virtual host may receive, through a virtual storage device interface, a debug bridge data packet that is sent by the debug bridge executable program in the form of a transmission protocol packet. Meanwhile, the debug bridge executable program may be unaware of the receipt of the debug bridge data packet by the virtual host.

In some embodiments, the virtual storage device may be a virtual USB device created based on a USB virtualization technology. The USB virtualization technology is a technology for supporting an external device of the virtual desktop, and is aimed at redirecting a local USB device to a remote end by means of network protocol transmission. In embodiments of the present application, the virtual USB device may refer to a virtual device that is simulated in a virtual machine through software and has the same functions as a hardware USB. In the virtual host, the virtual USB device may be recognized as a USB device accessing the virtual host and may perform the same functions as the device accessing the virtual host. For example, the virtual USB device serves as a USB device to perform data interaction with the ADB executable program running in the virtual host.

In some embodiments, a virtual host running in the server device can receive, through a virtual USB interface, the ADB data packet generated by the ADB executable program in the server device.

In step S306, the virtual host caches the debug bridge data packet and generates feedback information.

In step S306, after receiving the debug bridge data packet, the virtual host caches the debug bridge data packet and generates feedback information for the debug bridge data packet. The feedback information can be used for notifying the debug bridge executable program that transmission of the corresponding debug bridge data packet has been completed. The debug bridge data packet can be cached in a memory chip or other storage media such as a hard disk.

It is appreciated that, the transmission mode of sending a debug bridge data packet in the form of a transmission protocol packet to the Android device has a significant delay and low transmission efficiency. Therefore, in embodiments of the present application, a virtual host can be created in the service terminal device by means of the virtual machine technology. The virtual host may receive the debug bridge data packet in the form of the transmission protocol packet by using a virtual storage device technology. And the virtual host, instead of a target terminal device, can generate feedback information corresponding to the debug bridge data packet, to indicate that the target terminal device has received the debug bridge data packet. In embodiments of the present application, the transmission process consumes less time than a transmission process without the virtual host.

In some embodiments, after receiving an ADB data packet, the virtual host running in the server (e.g., an Aliyun server) can cache the ADB data packet and generate feedback information for the ADB data packet. Because both the ADB executable program and the virtual host run in the server, it takes a very short time to perform this step S306, and caching the ADB data packet can also significantly improve the data transmission rate.

In step S308, the virtual host returns the feedback information to the debug bridge executable program, such that the debug bridge executable program sends a newly generated debug bridge data packet to the virtual host. The debug bridge data packet can be remotely transmitted by the service terminal device to a target terminal device.

In step S308, in some embodiments, according to a debug bridge transmission protocol, the debug bridge executable program does not send a next debug bridge data packet until receiving feedback information indicating that the previous debug bridge data packet has been sent successfully. Data is exchanged between the service terminal device and the target terminal device through, for example, a network. The target terminal device, such as an Android device, can include all terminals running an Android system. For example, the target terminal device can include an Android phone, an Android tablet, an Android system-based smart TV, a terminal device running an Android emulator, etc.

It is appreciated that the newly generated debug bridge data packet is merely used for distinguishing from the previous debug bridge data packet.

In some embodiments, for the ADB executable program, after receiving the feedback information, the ADB executable program considers that the ADB data packet has been sent to the Android phone, and thus sends out a next ADB data packet. On the other hand, for the virtual host, the virtual host can directly or indirectly send the cached ADB data packet to the Android phone through the network interface, such that the Android phone carries out an operation or makes a response according to the ADB data packet after receiving the ADB data packet. Thus, rapid downlink transmission of the ADB data packet in the service terminal device to the Android phone is implemented. An indirect sending mode to the Android phone can include: sending, by the virtual host, the ADB data packet to the MicroPC, and sending, by the MicroPC, the ADB data packet to the Android phone through a USB interface.

It is appreciated that, in embodiments of the present application, an immediate feedback reply function is implemented in a virtual host added in a service terminal device to improve data transmission efficiency. The virtual host can cache a debug bridge data packet locally upon receipt of the debug bridge data packet, and returns feedback information for the debug bridge data packet to a debug bridge executable program that runs on the service terminal device locally. After receiving the feedback information, the debug bridge executable program can determine that the currently sent debug bridge data packet has been sent successfully, and therefore sends a next debug bridge data packet. Therefore, the efficiency of sending the debug bridge data packet of the debug bridge executable program can be improved, thereby implementing rapid downlink transmission of debug bridge data in the service terminal device to a target terminal device. Embodiments of the present application can achieve a technical effect of improving a data exchange rate between the debug bridge executable program in a virtual desktop and a debug bridge daemon process in the target terminal device, thereby solving the technical problem that management efficiency of an Android device is low in a remote system due to a low transmission rate during storage device virtualization in a debug bridge mode.

In some embodiments, in step S306, after the virtual host caches the debug bridge data packet, the following steps 53092 and S3094 may further be performed.

In step S3092, the virtual host converts the debug bridge data packet into a virtual data packet.

In some embodiments, in step S3092, the virtual host has another main function, e.g., parsing and processing a storage device virtualization protocol on the network. The virtual data packet can include service data converted from the debug bridge data packet by the virtual host according to the storage device virtualization protocol. The virtual host may simultaneously perform the step of converting the debug bridge data packet into a virtual data packet and the step of returning the feedback information to the debug bridge executable program.

In step S3094, the virtual host transmits the virtual data packet to an intermediate terminal device installed with a virtual client. After the virtual client obtains the debug bridge data packet by parsing the virtual data packet, the debug bridge data packet can be sent to the target terminal device through a storage device interface of the intermediate terminal device, and the target terminal device can access the intermediate terminal device through a storage device.

In step S3094 of the present application, the intermediate terminal device may be a computer terminal that has a physical storage device interface and can be connected to the Internet. The service terminal device establishes a connection to the intermediate terminal device through a network, and the target terminal device may establish a connection to the intermediate terminal device through the storage device interface. Corresponding to the virtual host, the virtual client runs in the intermediate terminal device, and also has the function of parsing and processing the storage device virtualization protocol on the network. Meanwhile, the virtual client may further monitor an inserted physical storage device, and initiate and manage a virtual storage device. The intermediate terminal device receives a virtual data packet generated by encapsulation according to the storage device virtualization protocol, and converts the virtual data packet into a debug bridge data packet in the form of a transmission protocol packet also according to the storage device virtualization protocol.

In some embodiments, the virtual host in the cloud server (e.g., Aliyun) converts the ADB data packet into a virtual data packet according to a USB virtualization protocol, and transmits the virtual data packet to the virtual client in the intermediate terminal device through the network. The virtual client converts the virtual data packet into the ADB data packet also according to the USB virtualization protocol, and transmits the ADB data packet to the Android phone through a physical USB interface.

It is appreciated that, step S3092 to step S3094 of the present application provide an optional solution of transmitting, by the service terminal device, the debug bridge data packet to the target terminal device. By means of coordination between a virtual client added in the service terminal device and the intermediate terminal device and the virtual host in the service terminal device, the process of sending, by the virtual host, the debug bridge data packet to an Android device is implemented.

In an optional solution provided in the foregoing embodiments of the present application, after the target terminal device receives the debug bridge data packet remotely transmitted by the service terminal device, the following implementation steps S312-S318 may further be performed.

In step S312, a debug bridge daemon process running on the target terminal device generates a debug bridge reply data packet according to the debug bridge data packet.

In step S312 of the present application, the debug bridge daemon process is a background process running in an Android device or an emulator. The debug bridge daemon process can be used for parsing, in coordination with the debug bridge executable program running on the service terminal device, the transmission protocol packet on the storage device interface. The debug bridge daemon process can be further used for responding to the service request initiated by the debug bridge executable program, and providing a service for the debug bridge executable program. For example, the debug bridge daemon process is used to be connected to a debug bridge service process and provide a service for a debug bridge client running on a host. The debug bridge reply data packet can include service data generated by the debug bridge daemon process in response to the service request in the debug bridge data packet.

It is appreciated that, in the some embodiments where the debug bridge is applicable to an Android system, the debug bridge daemon process may be an ADB daemon process, and may manifest as an ADB daemon. The debug bridge reply data packet may manifest as an ADB reply data packet, and includes service data that is generated by the ADB daemon in response to the service request in the debug bridge data packet.

In some embodiments, an ADB daemon process running in the Android phone can parse the ADB data packet transmitted thereto through the USB interface of the Android phone and generate a reply data packet. The reply data packet is used for notifying the ADB executable program of the ADB data packet being successfully received, and/or used for returning data indicated by the service request in the ADB data packet.

In step S314, the debug bridge daemon process transmits the debug bridge reply data packet to the virtual client through the storage device.

In step S314 of the present application, data can be exchanged between the target terminal device and the intermediate terminal device through the storage device.

In step S316, the virtual client caches the debug bridge reply data packet and generates feedback reply information.

In step S316 of the present application, after receiving the debug bridge reply data packet, the virtual client can cache the debug bridge reply data packet and generate feedback reply information for the debug bridge reply data packet. The feedback reply information can be used for notifying the debug bridge daemon process that transmission of the corresponding debug bridge reply data packet has been completed, though the debug bridge executable program has not received the debug bridge reply data packet yet at the moment. The debug bridge reply data packet can be cached in a memory chip of a hard disk controller or in a hard disk or other storage media.

In step S318, the virtual client returns the feedback reply information to the debug bridge daemon process, and starts the debug bridge daemon process to send a newly generated debug bridge reply data packet.

It is appreciated that, when the virtual client is not provided, the debug bridge reply data packet can be sent to the remote service terminal device. The debug bridge reply data packet can be received and processed by the debug bridge executable program running in the service terminal device. The target terminal device does not send out a next debug bridge reply data packet until the target terminal device confirms that the debug bridge reply data packet is received by the service terminal device. In embodiments of the present application, a virtual client is created in the target terminal device by means of virtual machine technology. The virtual client can receive the debug bridge reply data packet in the form of a transmission protocol packet by means of the virtual storage device technology. And the virtual client, rather than the service terminal device, can generate feedback reply information corresponding to the debug bridge data packet. The transmission process in embodiments of the present application consumes less time than the transmission process without the virtual client.

In some embodiments, a virtual client runs in the MicroPC. The virtual client receives an ADB reply data packet that is returned by the Android phone through the USB interface, and generates feedback reply information for the ADB reply data packet, so that the Android phone quickly sends a next ADB reply data packet. Because the virtual client and the Android phone are connected through a physical USB, it takes a very short time to perform the foregoing step, and caching itself can also significantly improve the data transmission rate.

It is appreciated that, step S312 to step S318 of the present application provide an optional solution for data transmission between the virtual client and the debug bridge daemon process in the target terminal device. An immediate feedback reply function is implemented in the virtual client added in the intermediate terminal device to improve data transmission efficiency. First, the virtual client caches a debug bridge reply data packet locally upon receipt of the debug bridge reply data packet, and returns feedback reply information for the debug bridge reply data packet to the debug bridge daemon process running in the target terminal device. After receiving the feedback reply information, the debug bridge daemon process can determine that the currently sent debug bridge reply data packet has been sent successfully. Therefore, the debug bridge daemon process can send a next debug bridge reply data packet. Thus, the efficiency of sending the debug bridge reply data packet of the debug bridge daemon process can be improved, thereby implementing rapid uplink transmission of debug bridge reply data in the target terminal device to the service terminal device.

Embodiments of the present application can improve a data exchange rate between the debug bridge executable program in a remote system and the debug bridge daemon process in the target terminal device, thereby solving the technical problem that management efficiency of an Android device is low in a remote system due to a low transmission rate during storage device virtualization in a debug bridge mode.

In some embodiments of the present application, the virtual client creates a second cache region locally, wherein the second cache region is used for caching the debug bridge reply data packet.

For example, caching the debug bridge reply data packet by the virtual client can include: creating a cache region, such as a cache pool, for a debug bridge device, to cache the debug bridge reply data packet transmitted uplink by the debug bridge daemon process to the debug bridge executable program.

It is appreciated that, in the current storage device virtualization solution, the debug bridge of the Android phone is redirected to a virtual machine for use, and the speed thereof is only at a KB level. When software, such as a mobile phone assistant, is used in the virtual machine to carry out management, the delay can be very significant and the user experience can be rather poor. Therefore, embodiments of the present application design a set of cache mechanisms for storage device virtualization transmission of the debug bridge. For example, a cache pool for caching debug bridge reply data packets can be implemented in the virtual client of the intermediate terminal device. Inside the intermediate terminal device, a debug bridge data packet is acquired in advance by returning feedback reply information through a physical storage device interface, and is filled into the cache pool, so that the transmission speed can increase from the KB level to the megabyte (MB) level.

In some embodiments, in step S316, after the virtual client caches the debug bridge reply data packet, the following implementation steps S3192 and S3194 may further be performed.

In step S3192, the virtual client converts the debug bridge reply data packet into a virtual reply data packet.

In step S3192 of the present application, the virtual client further has another main function, e.g., parsing and processing the storage device virtualization protocol on the network. The virtual reply data packet can include service data converted from the debug bridge reply data packet by the virtual client according to the storage device virtualization protocol. The virtual client may simultaneously perform the step of converting the debug bridge reply data packet into a virtual data packet and the step of returning the feedback reply information to the debug bridge daemon process.

In step S3194, the virtual client transmits the virtual reply data packet to the service terminal device installed with the virtual host. After the virtual host obtains the debug bridge reply data packet by parsing the virtual reply data packet, the debug bridge reply data packet can be sent to the debug bridge executable program through the virtual storage device.

In step S3194 of the present application, data can be transmitted between the service terminal device and the intermediate terminal device through the Internet. The service terminal device receives the virtual reply data packet generated by encapsulation according to the storage device virtualization protocol, and converts the virtual reply data packet into the debug bridge reply data packet in the form of a transmission protocol packet also according to the storage device virtualization protocol. The virtual host running in the service terminal device may further send the debug bridge reply data packet to the debug bridge executable program through the virtual storage device interface.

For example, the virtual client running in the MicroPC can send, through the network, a cached virtual reply data packet to the virtual host running in the server (e.g., Aliyun server). The virtual host can then convert the virtual reply data packet into an ADB reply data packet according to a USB virtualization transmission protocol, and send the ADB reply data packet to the ADB executable program.

Step S30192 to step S30194 of the present application provide an optional solution of sending, by the intermediate terminal device, the cached debug bridge reply data packet to the debug bridge executable program. The debug bridge reply data packet is converted into a virtual reply data packet on the basis of step S30192, and then the virtual reply data packet is transmitted to the service terminal device by performing step S30194, thereby implementing transmission of the debug bridge reply data packet to the debug bridge executable program.

For example, after the virtual host in the service terminal device receives the virtual reply data packet sent by the intermediate terminal device and converts the virtual reply data packet into the debug bridge reply data packet, the following step may further be performed: matching the received debug bridge reply data packet with the sent debug bridge data packet. That is, it is checked that whether the feedback information returned by the virtual host to the debug bridge executable program is consistent with the received debug bridge reply data packet. If the feedback information and the received debug bridge reply data packet are consistent, it can be determined that the debug bridge data packet has successfully arrived at the target terminal device. If a debug bridge reply data packet matching the debug bridge data packet is still not received in a predetermined condition, it can be determined that the debug bridge data packet is not transmitted successfully. In this case, the virtual host may re-send the debug bridge data packet that is not transmitted successfully. Or the virtual host may request the debug bridge executable program to re-send the debug bridge data packet that is not transmitted successfully. The predetermined condition may be a predetermined time interval, or a predetermined debug bridge data packet sending amount.

In some embodiments, the virtual host transmitting the virtual data packet to an intermediate terminal device installed with a virtual client further includes the following specific steps S3102-S3016.

In step S3102, the virtual host sequentially makes timestamps on the generated multiple virtual data packets.

In step S3102 of the present application, the timestamp may be information identifying a generation time of the virtual data packet or may be information identifying time when the virtual host receives the debug bridge data packet corresponding to the virtual data packet. In some embodiments, the sequence for the virtual host to send virtual data packets is the sequence for the service terminal device to send debug bridge data packets. However, data packets may be out of order due to a network delay or other situations. Therefore, by adding timestamps in virtual data packets, it is ensured that the virtual data packets are sent according to a certain sequence.

In step S3104, multiple virtual data packets having timestamps are hashed into data packets in a cache queue.

In step S3104 of the present application, hashing in embodiments of the present application may be interpreted as transforming a virtual data packet with a random length into a data packet with a fixed length by using a hash algorithm.

In step S3106, the data packets in the cache queue are sorted and/or screened, and the data packets in the cache queue are sent to the target terminal device according to a preset transmission strategy. The transmission strategy can be associated with transmission priorities of the data packets in the cache queue.

In step S3106 of the present application, the transmission strategy, for example, includes: setting transmission priorities for the data packets in the cache queue according to the timestamps of the virtual data packets, sizes of the virtual data packets, whether the virtual data packet is an invalid packet and whether the virtual data packet is a redundant packet, or other strategies. The transmission priority is used for indicating the sequence in which the virtual host sends the virtual data packets.

Step S3102 to step S3106 of the present application provide an optional solution of transmitting, by the virtual host, the virtual data packet to the intermediate terminal device installed with the virtual client. Embodiments of the present application implement optimal setting of the sequence in which the virtual host sends virtual data packets, and improve a transmission rate between the virtual host and the virtual client. It should be noted that, after being modified adaptively, the embodiments may further be applied to the step of sending, by the virtual client, the virtual reply data packet to the virtual host.

In some embodiments of the present application, the debug bridge executable program at least includes: a debug bridge client and a debug bridge service process. Step S302 of generating, by a debug bridge executable program running in a service terminal device, a debug bridge data packet further includes the following specific steps S3022-S3026.

In step S3022, the debug bridge client running in the service terminal device initiates a service request to the debug bridge service process.

In step S3024, the debug bridge service process parses the service request to generate a service data packet.

In step S3026, the debug bridge service process encapsulates the service data packet according to a debug bridge transmission protocol to generate the debug bridge data packet.

It is appreciated that, in the foregoing embodiments(e.g., the debug bridge being applicable to an Android system), the debug bridge client may be an ADB client, and may specifically manifest as an ADB client. The debug bridge service process may be an ADB service process, and may specifically manifest as an ADB server.

In step S3022 to step S3026 of the present application, the debug bridge executable program further specifically includes a debug bridge client and a debug bridge service process. The debug bridge client is used for generating a debug bridge service request packet after parsing a command input by a user, and sending the request to the debug bridge service process through a local socket. On one hand, the debug bridge service process is used for parsing and replying to the service request of the client. On the other hand, if the service request needs to be completed in coordination with a terminal, the debug bridge service process initiates a service to the terminal, encapsulates the service request into a transmission protocol packet, and interacts with the terminal through a virtual storage device interface.

Step S3022 to step S3026 of the present application provide an additional embodiments of generating a debug bridge data packet by the debug bridge executable program. A service request is initiated on the basis of step S3022, a service data packet is generated through step S3024, and the service data is encapsulated into a debug bridge data packet in the form of a transmission protocol packet by performing step S3026.

In some embodiments of the present application, in step S304, before a virtual host running on the service terminal device receives the debug bridge data packet through a pre-created virtual storage device, the following implementation step S303 may further be performed.

In step S303, the virtual host pre-creates the virtual storage device locally, and creates a first cache region locally, wherein the first cache region is used for caching the debug bridge data packet.

In step S303 of the present application, an optional manner of caching the debug bridge data packet by the virtual host can include: creating a cache region such as a cache pool, to cache the debug bridge data packet that is transmitted downlink by the debug bridge service process to the debug bridge daemon process.

It is appreciated that, in the conventional USB virtualization solution, the ADB of the Android phone is redirected to a virtual machine for use, and the speed thereof is only at a KB level. When software such as a mobile phone assistant is used in the virtual machine to carry out management, the delay is very significant and the user experience is rather poor. Therefore, embodiments of the present application design a set of cache mechanisms for USB virtualization transmission of the ADB. For example, a cache pool for caching ADB data packets is implemented in the virtual host of the service terminal. Inside the service terminal, an ADB data packet is acquired in advance by means of a USB virtual request, and is filled into the cache pool. When an ADB request is received, a reply packet is searched for in the cache pool, so that the transmission speed is increased from the KB level to the MB level.

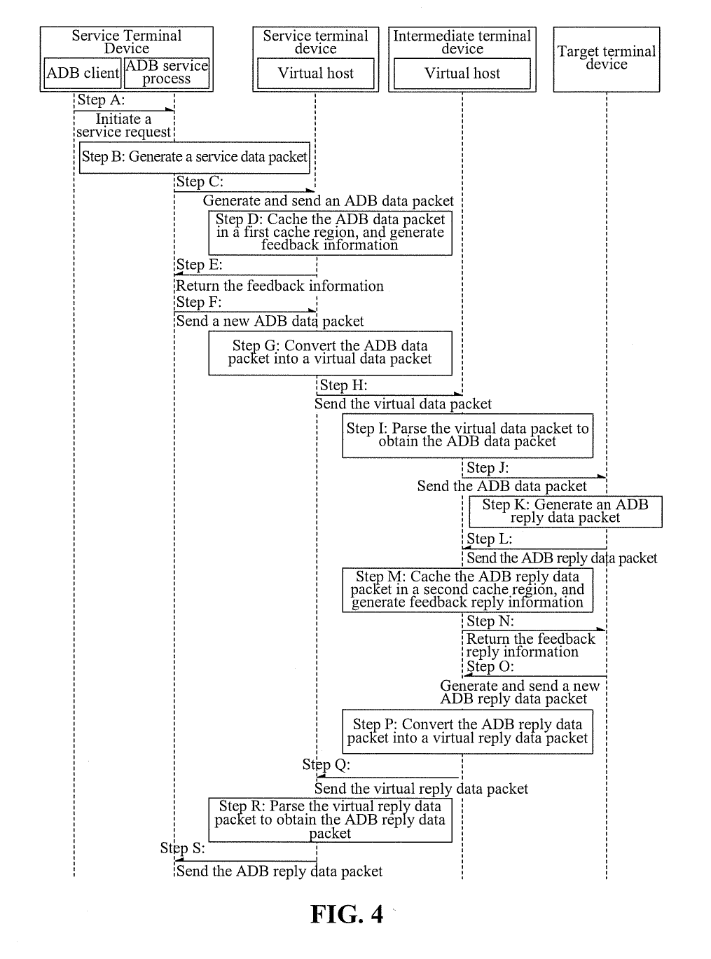

When the solution of the present application is applied to an application scenario, functions can be implemented and described in detail hereinafter with reference to FIG. 4.

In step A, a service request is initiated. The service request may be initiated to an ADB service process by using an ADB client running in a service terminal device.

In step B, a service data packet is generated. The ADB service process parses the service request to generate the service data packet.

In step C, an ADB data packet is generated and sent. The ADB service process encapsulates, according to an ADB transmission protocol, the service data packet obtained through parsing to generate the ADB data packet.

In step D, the ADB data packet is cached in a first cache region, and feedback information is generated. A virtual host running on the service terminal device receives the ADB data packet through a pre-created virtual USB device. After receiving the ADB data packet, the virtual host caches the ADB data packet in the local first cache region, and generates feedback information for the ADB data packet. The feedback information is used for notifying an ADB executable program that transmission of the corresponding ADB data packet has been completed.

In step E, the feedback information is returned. The virtual host returns the feedback information to the ADB executable program.

In step F, a new ADB data packet is generated and sent to a virtual host running on a service terminal device. After receiving the feedback information indicating that the previous ADB data packet has been sent successfully, the ADB executable program may send the next ADB data packet to the virtual host running on the service terminal device.

In step G, the ADB data packet is converted into a virtual data packet. The virtual host has the function of parsing and processing a USB virtualization protocol on a network, and converts the ADB data packet into a virtual data packet according to the USB virtualization protocol.

In step H, the service terminal device may remotely send the virtual data packet obtained after the conversion to an intermediate terminal device through a network. In particular, the service terminal device establishes a connection to the intermediate terminal device through the network. A virtual client runs in the intermediate terminal device. The service terminal device sends, through the network, the virtual data packet to the virtual client installed on the intermediate terminal device.

In step I, the intermediate terminal device parses the virtual data packet to obtain the ADB data packet. Corresponding to the virtual host, the virtual client runs in the intermediate terminal device and also has the function of parsing and processing the USB virtualization protocol on the network. Meanwhile, the virtual client may further monitor an inserted USB physical device, and initiate and manage a virtual USB device.

In step J, the intermediate terminal device sends the ADB data packet to a target terminal device. After obtaining the ADB data packet by parsing the virtual data packet, the virtual client sends the ADB data packet to the target terminal device through a USB interface of the intermediate terminal device.

In step K, the target terminal device generates an ADB reply data packet. In particular, an ADB daemon process running on the target terminal device generates the ADB reply data packet according to the ADB data packet. The ADB reply data packet is service data that is generated by the ADB daemon process in response to the service request in the ADB data packet.

In step L, the target terminal device returns the ADB reply data packet to the intermediate terminal device. The target terminal device and the intermediate terminal device exchange data through a USB device. The ADB daemon process transmits the ADB reply data packet to the virtual client on the target terminal device through the USB device.

In step M, the intermediate terminal device caches the ADB reply data packet in a local second cache region, and generates feedback reply information. After receiving the ADB reply data packet through the USB interface, the virtual client running on the intermediate terminal device caches the ADB reply data packet, and generates feedback reply information for the ADB reply data packet. The feedback reply information is used for notifying the ADB daemon process that transmission of the corresponding ADB reply data packet has been completed.

In step N, the virtual client returns the feedback reply information to the target terminal device. The virtual client may return the feedback reply information to the ADB daemon process on the target tenninal device.

In step O, the target terminal device generates and returns a new ADB reply data packet. After the ADB daemon process in the target terminal device confirms that the ADB reply data packet is received by the ADB executable program in the service tenninal device, the ADB daemon process in the target terminal device may send out a next ADB reply data packet.

In step P, the intermediate terminal device converts the ADB reply data packet into a virtual reply data packet. The virtual reply data packet is service data that is converted by the virtual client from the ADB reply data packet according to the USB virtualization protocol. The virtual client further has the function of parsing and processing the USB virtualization protocol on the network.

In step Q, the intermediate terminal device returns the virtual reply data packet to the service terminal device. Data is transmitted between the service terminal device and the intermediate terminal device through the Internet. The virtual client transmits the virtual reply data packet to the service terminal device installed with the virtual host.

In step R, the service terminal device parses the virtual reply data packet to obtain the ADB reply data packet. The virtual host in the service terminal device converts the virtual reply data packet into the ADB reply data packet in the form of a transmission protocol packet according to the USB virtualization protocol.

In step S, the virtual host in the service terminal device sends the ADB reply data packet. In particular, the virtual host sends the ADB reply data packet to the ADB executable program through the virtual USB device, such that the ADB executable program parses the ADB reply data packet to obtain data uploaded by the target terminal device.

Step A to step J can implement sending the ADB data packet generated by the ADB executable program in the service terminal device downlink to the ADB daemon process in the target terminal device. Step K to step S can implement sending the ADB reply data packet generated by the ADB daemon process in the target terminal device uplink to the ADB executable program in the service terminal device.

The transmission rate in the ADB mode in current various USB virtualization redirection methods is conventionally at a KB level. At such a rate, many kinds of software such as the mobile phone assistant cannot be normally used in a remote system, which significantly restricts use of an Android phone in systems such as a virtual desktop. However, the data transmission method according to embodiments of the present application creates a set of cache mechanisms for ADB transmission, such that the transmission speed of the ADB increases to the MB level. Therefore, the Android phone can be smoothly used in the remote system.

It should be noted that, for ease of description, the foregoing embodiments are all expressed as a series of action combinations. However, it is appreciated that that the present application is not limited to the described action sequence. Because according to the present application, some steps may be performed in other sequences or simultaneously.

Through the description of the above implementation modes, it is appreciated that the method according to the foregoing embodiments may be implemented by software plus a necessary hardware platform, and of course may also be implemented by hardware. However, in many cases, the former is a better mode of implementation. Based on such an understanding, the embodiments may be implemented in the form of a software product. The computer software product is stored in a storage medium (such as a ROM/RAM, a magnetic disk, or an optical disc) and includes several instructions to enable a terminal device (which may be a mobile phone, a computer, a server, a network device or the like) to execute the method in each embodiment of the present application.

A method of a virtual machine-based data transmission is further provided according to embodiments of the present application. It should be noted that steps shown in the flowchart of the accompanying drawing may be executed in a computer system such as a group of computer executable instructions. In addition, although a logic sequence is shown in the flowchart, the steps shown or described may be performed in a sequence different from the sequence herein in some cases.

It is appreciated that the virtual machine-based data transmission method can be performed by the computer terminal shown in FIG. 2.

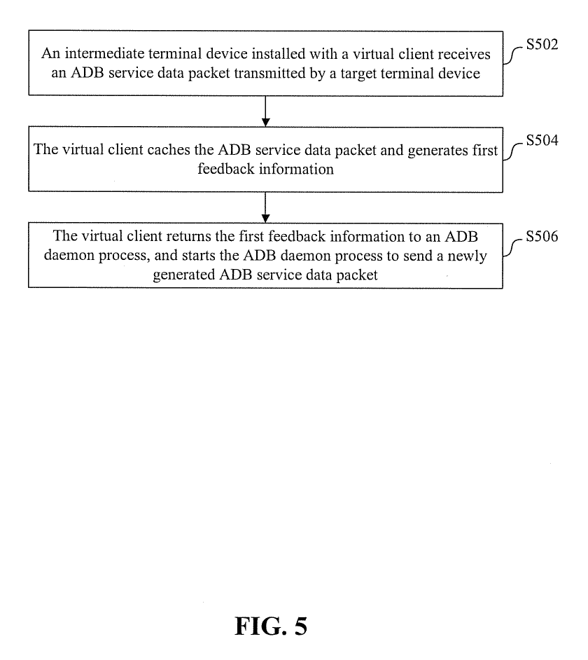

In the foregoing running environment, the present application provides a virtual machine-based data transmission method as shown in FIG. 5. FIG. 5 is a flowchart of a virtual machine-based data transmission method of the present application. As shown in FIG. 5, an optional virtual machine-based data transmission method includes the following implementation steps S502-S506.

In step S502, an intermediate terminal device installed with a virtual client receives a debug bridge service data packet transmitted by a target terminal device. The target terminal device generates the debug bridge service data packet by using a debug bridge daemon process, and transmits the debug bridge service data packet to the virtual client through a storage device.

In step S502 of the present application, the intermediate terminal device may be a computer terminal that has a physical storage device interface and can be connected to the Internet. The target terminal device may establish a connection to the intermediate terminal device through the storage device interface. The target terminal device, such as an Android device, in embodiments of the present application includes all terminals running an Android system, such as, an Android phone, an Android tablet, an Android system-based smart TV, a terminal device running an Android emulator, etc. The virtual client runs in the intermediate terminal device and has the function of parsing and processing a storage device virtualization protocol on a network. Meanwhile, the virtual client may further monitor an inserted physical storage device, and initiate and manage a virtual storage device.

It is appreciated that the debug bridge daemon process may manifest as an ADB daemon, and is a background process running in the target terminal device, such as an Android device or an emulator. The debug bridge daemon process is used for coordinating with a debug bridge executable program running on a service terminal device, parsing a transmission protocol packet on the storage device interface, responding to a service request initiated by the debug bridge executable program, and providing a service for the debug bridge executable program. The debug bridge service data packet is service data, in the form of a transmission protocol packet, generated by the debug bridge daemon process according to a debug bridge transmission protocol.

In step S504, the virtual client caches the debug bridge service data packet, and generates first feedback information.

In step S504 of the present application, after receiving the debug bridge service data packet, the virtual client caches the debug bridge service data packet, and generates first feedback information for the debug bridge reply data packet. The first feedback information is used for notifying the debug bridge daemon process that transmission of the corresponding debug bridge reply data packet has been completed, though the debug bridge executable program has not received the debug bridge reply data packet at the moment yet. The debug bridge service data packet can be cached in a memory chip of a hard disk controller or in a hard disk or other storage media.

In step S506, the virtual client returns the first feedback information to the debug bridge daemon process, and starts the debug bridge daemon process to send a newly generated debug bridge service data packet.

The debug bridge service data packet is remotely transmitted by the intermediate terminal device to a service terminal device.

It is appreciated that, when the virtual client is not provided, the debug bridge service data packet is sent to the remote service terminal device and is received and processed by the debug bridge executable program running in the service terminal device. The target terminal device does not send out a next debug bridge service data packet until the target terminal device confirms that the debug bridge service data packet is received by the service terminal device. In embodiments of the present application, a virtual client is created in the target terminal device by means of the virtual machine technology. The virtual client can receive the debug bridge service data packet in the form of a transmission protocol packet by means of a virtual storage device technology. And the virtual client, rather than the service terminal device, can generate first feedback information for the debug bridge data packet. The transmission process in embodiments of the present application consumes less time than the transmission process without the virtual client.

It should be further noted herein that the service terminal device establishes a connection to the intermediate terminal device through the network.

It is appreciated that step S502 to step S506 of the present application provide a solution for data transmission between the virtual client and the debug bridge daemon process in the target terminal device. An immediate feedback reply function is implemented in the virtual client added in the intermediate terminal device to improve data transmission efficiency. First, the virtual client caches a debug bridge reply data packet locally upon receipt of the debug bridge reply data packet, and returns feedback reply information for the debug bridge reply data packet to the debug bridge daemon process running in the target terminal device. After receiving the feedback reply information, the debug bridge daemon process can determine that the currently sent debug bridge reply data packet has been sent, and therefore sends a next debug bridge reply data packet, thus achieving an objective of improving debug bridge reply data packet sending efficiency of the debug bridge daemon process, thereby implementing rapid uplink transmission of debug bridge reply data in the target terminal device to the service terminal device. The foregoing solution achieves a technical effect of improving a data exchange rate between the debug bridge executable program in a remote system and the debug bridge daemon process in the target terminal device, thereby solving the technical problem that management efficiency of an Android device is low in a remote system due to a low transmission rate during storage device virtualization in a debug bridge mode.

In some embodiments of the present application, the virtual client creates a cache region locally, wherein the cache region is used for caching the debug bridge service data packet.

In some embodiments of the present application, caching the debug bridge service data packet by the virtual client involves creating a cache region, such as a cache pool, for a debug bridge device, to cache the debug bridge service data packet transmitted uplink by the debug bridge daemon process to the debug bridge executable program.

It is appreciated that, in the current USB virtualization solution, the ADB of the Android phone is redirected to a virtual machine for use, and the speed thereof is only at a KB level. When software such as a mobile phone assistant is used in the virtual machine to carry out management, the delay is very significant and the user experience is rather poor. Therefore, the solution provided in embodiments of the present application designs a set of cache mechanisms for USB virtualization transmission of the ADB, i.e., a cache pool for caching ADB service data packets is implemented in the virtual client of the intermediate terminal device. Inside the intermediate terminal device, an ADB service data packet is acquired in advance by returning first feedback information through a physical USB interface, and is filled into the cache pool, so that the transmission speed can increase from the KB level to the MB level.

In some embodiments of the present application, in step S504, after the virtual client caches the debug bridge service data packet, the following implementation steps S512 and S514 may further be performed.

In step S512, the virtual client converts the debug bridge service data packet into a virtual service data packet.

In step S512 of the present application, the virtual client further has another main function, e.g., parsing and processing the storage device virtualization protocol on the network. The virtual service data packet can include service data converted from the debug bridge service data packet by the virtual client according to the storage device virtualization protocol. The virtual client may simultaneously perform the step of converting the debug bridge service data packet into a virtual service data packet and the step of returning the first feedback information to the debug bridge daemon process.

In step S514, the virtual client transmits the virtual service data packet to the service terminal device installed with a virtual host.

After the virtual host obtains the debug bridge service data packet by parsing the virtual service data packet, the debug bridge service data packet is sent, through a virtual storage device pre-created by the virtual host, to a debug bridge executable program running on the service terminal device.

In step S514 of the present application, the service terminal device in embodiments of the present application is a collective term for remote devices, for example, a server of a data center. The debug bridge executable program is a collective term for debug bridge-related processes running in the service terminal device, and manifests as an ADB.exe program in the service terminal device. The debug bridge data packet is service data generated by the debug bridge executable program according to a debug bridge protocol. The debug bridge executable program parses a command input by a user to generate a debug bridge service request, and encapsulates the debug bridge service request in the debug bridge data packet. The virtual host runs in the service terminal device. The virtual host, which is a host created in the remote system by means of virtualization, may create a virtual storage device and manage the created virtual storage device. The virtual host may receive, through a network interface, a virtual service data packet sent by the virtual client, and complete converting the virtual service data packet into the debug bridge service data packet according to the storage device virtualization protocol, and may further send the debug bridge service data packet to the debug bridge executable program through the virtual storage device interface.

Step S512 to step S514 of the present application provide an optional solution of sending, by the intermediate terminal device, the cached debug bridge reply data packet to the debug bridge executable program. The debug bridge reply data packet is converted into a virtual reply data packet on the basis of step S512, and the virtual reply data packet is transmitted to the service terminal device by performing step S514, thus finally implementing transmission of the debug bridge reply data packet to the debug bridge executable program.

In some embodiments of the present application, the debug bridge executable program at least includes: a debug bridge client and a debug bridge service process. After the debug bridge service data packet is sent to the debug bridge executable program running on the service terminal device, the method further includes steps S515-S517.

In step S515, the debug bridge service process running in the service terminal device parses the debug bridge service data packet.

In step S516, the debug bridge service process encapsulates the parsed debug bridge service data packet to generate a service-type data packet.

In step S517, the debug bridge service process sends the generated service-type data packet to the debug bridge client.

In step S515 to step S517 of the present application, the debug bridge executable program further includes a debug bridge client and a debug bridge service process. The debug bridge client manifests as an ADB client in the service terminal device and is used for generating a debug bridge service request packet after parsing a command input by a user, and sending the request to the debug bridge service process through a local socket. The debug bridge service process manifests as an ADB server in the service terminal device. On the one hand, the debug bridge service process is used for parsing and replying to the service request of the ADB client. On the other hand, if the service request needs to be completed in coordination with a terminal, the debug bridge service process initiates a service to the terminal, encapsulates the service request into a transmission protocol packet, and interacts with the terminal through a storage device interface of the debug bridge.

It is appreciated that step S515 to step S517 of the present application provide an optional solution of generating a debug bridge data packet by the debug bridge executable program. A service request is initiated on the basis of step S515, a service data packet is generated through step S516, and the service data is encapsulated into a debug bridge data packet in the form of a transmission protocol packet by performing step S517.

It should be noted that, for ease of description, the foregoing method embodiments are all expressed as a series of action combinations. However, it is appreciated that the present application is not limited to the described action sequence, because according to the present application, some steps may be performed in other sequences or simultaneously.

Through the description of the implementation mode above it is appreciated that the method according to the foregoing embodiments may be implemented by software plus a necessary hardware platform, and may also be implemented by hardware. However, in many cases, the former is a better mode of implementation. Based on such an understanding, embodiments may be embodied in the form of a software product. The software product can be stored in a storage medium (such as a ROM/RAM, a magnetic disk, or an optical disc) and include several instructions to enable a terminal device (which may be a mobile phone, a computer, a server, a network device or the like) to execute the method in each embodiment of the present application.

A virtual machine-based data transmission apparatus for implementing the foregoing virtual machine-based data transmission method is further provided according to embodiments of the present application. The apparatus provided in embodiments of the present application may run on a computer terminal.

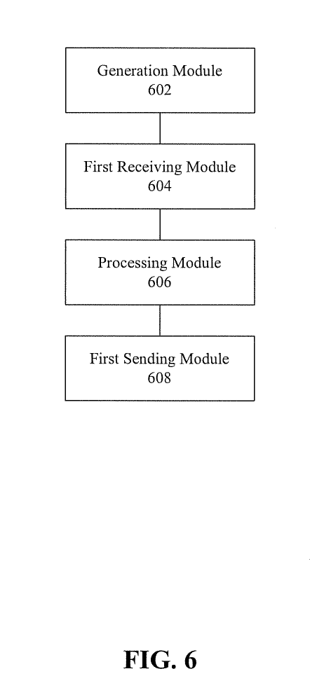

FIG. 6 is a schematic structural diagram of a virtual machine-based data transmission apparatus according to some embodiments of the present application. As shown in FIG. 6, the virtual machine-based data transmission apparatus includes: a generation module 602, a first receiving module 604, a processing module 606, and a first sending module 608.

Generation module 602 can be configured to enable a debug bridge executable program running in a service terminal device to generate a debug bridge data packet.

First receiving module 604 can be configured to enable a virtual host running on the service tenninal device to receive the debug bridge data packet through a pre-created virtual storage device.

Processing module 606 can be configured to enable the virtual host to cache the debug bridge data packet and generate feedback information.

First sending module 608 can be configured to enable the virtual host to return the feedback information to the debug bridge executable program, such that the debug bridge executable program sends a newly generated debug bridge data packet to the virtual host.

The debug bridge data packet is remotely transmitted by the service tenninal device to a target terminal device.

It is appreciated that an immediate feedback reply function is implemented in a virtual host added in a service terminal device to improve data transmission efficiency. First, the virtual host caches a debug bridge data packet locally upon receipt of the debug bridge data packet, and returns feedback information for the debug bridge data packet to a debug bridge executable program that runs on the service terminal device locally. After receiving the feedback information, the debug bridge executable program can determine that the currently sent debug bridge data packet has been sent, and therefore sends a next debug bridge data packet. Thus, the efficiency of sending the debug bridge data packet of the debug bridge executable program can be improved, thereby implementing rapid downlink transmission of debug bridge data in the service terminal device to a target terminal device. A data exchange rate between the debug bridge executable program in a virtual desktop and a debug bridge daemon process in the target terminal device can be improved, thereby solving the technical problem that management efficiency of an Android device is low in a remote system due to a low transmission rate during storage device virtualization in a debug bridge mode.

It is appreciated that the foregoing generation module 602, first receiving module 604, processing module 606 and first sending module 608 correspond to step S302 to step S308 of FIG. 3. Implemented examples and application scenarios of the four modules can be the same or similar as those of the corresponding steps, but are not limited to the content. It should be noted that the foregoing modules, as a part of the apparatus, may run in the computer terminal 10 of FIG. 2, and may be implemented by software or implemented by hardware.

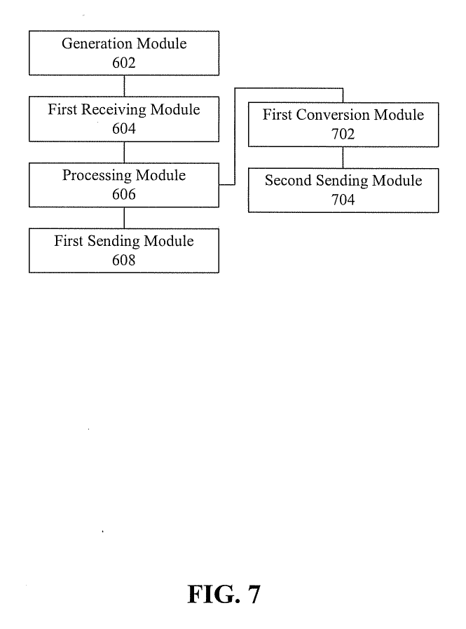

In some embodiments, FIG. 7 is a schematic structural diagram of an optional virtual machine-based data transmission apparatus according to the embodiments shown in FIG. 6 of the present application. As shown in FIG. 7, the virtual machine-based data transmission apparatus according to embodiments of the present application further includes: a first conversion module 702 and a second sending module 704.

First conversion module 702 can be configured to enable the virtual host to convert the debug bridge data packet into a virtual data packet.

Second sending module 704 can be configured to enable the virtual host to transmit the virtual data packet to an intermediate terminal device installed with a virtual client.

After the virtual client obtains the debug bridge data packet by parsing the virtual data packet, the debug bridge data packet is sent to the target terminal device through a storage device interface of the intermediate terminal device, and the target terminal device accesses the intermediate terminal device through a storage device.

It is appreciated that first conversion module 702 and second sending module 704 of the present application provide an optional solution of transmitting, by the service terminal device, the debug bridge data packet to the target terminal device. By means of coordination between a virtual client and the virtual host in the service terminal device, the virtual client being added in the service terminal device and the intermediate terminal device, the process of sending, by the virtual host, the debug bridge data packet to an Android device is implemented.

It is appreciated that foregoing first conversion module 702 and second sending module 704 correspond to step S3092 to step S3094. Implemented examples and application scenarios of the two modules can be same or similar as those of the corresponding steps, but are not limited to the content. It should be noted that the foregoing modules, as a part of the apparatus, may run in computer terminal 10 of FIG. 2, and may be implemented by software or implemented by hardware.

Optionally, the virtual machine-based data transmission apparatus according to embodiments of the present application further includes: a second receiving module, a second conversion module and a third sending module.

The second receiving module can be configured to enable the service terminal device installed with the virtual host to receive a virtual reply data packet transmitted by the virtual client.

The second conversion module can be configured to parse the virtual reply data packet to obtain a debug bridge reply data packet.

The third sending module can be configured to enable the virtual storage device to send the debug bridge reply data packet to the debug bridge executable program.

The debug bridge daemon process running on the target terminal device generates a debug bridge reply data packet according to the debug bridge data packet and transmits the debug bridge reply data packet to the virtual client through the storage device. The virtual client caches the debug bridge reply data packet and generates feedback reply information. The virtual client returns the feedback reply information to the debug bridge daemon process, and starts the debug bridge daemon process to send a newly generated debug bridge reply data packet. The virtual client converts the debug bridge reply data packet into a virtual reply data packet.

It is appreciated that the technical solution provided by the foregoing second receiving module, second conversion module and third sending module corresponds to the technical solution provided by step S312 to step S318 and step S3192 to step S3194. Implemented examples and application scenarios of the three modules are the same as those of the corresponding steps, but are not limited to the content. It should be noted that the foregoing modules, as a part of the apparatus, may run in computer terminal 10 of FIG. 2, and may be implemented by software or implemented by hardware.

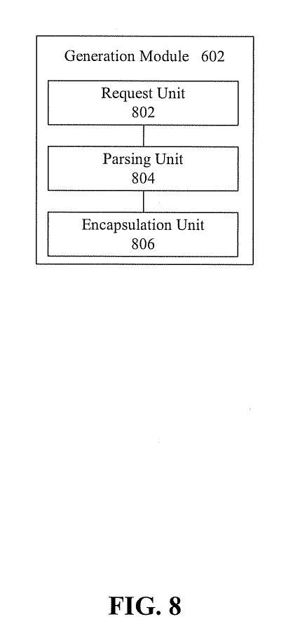

Optionally, FIG. 8 is a schematic structural diagram of an optional generation module according to embodiments shown in FIG. 6 of the present application. As shown in FIG. 8, the generation module of the virtual machine-based data transmission apparatus according to embodiments of the present application includes: a request unit 802, a parsing unit 804 and an encapsulation unit 806.

Request unit 802 can be configured to enable the debug bridge client running in the service terminal device to initiate a service request to the debug bridge service process.

Parsing unit 804 can be configured to enable the debug bridge service process to parse the service request to generate a service data packet.

Encapsulation unit 806 can be configured to enable the debug bridge service process to encapsulate the service data packet according to a debug bridge transmission protocol to generate the debug bridge data packet.

It is appreciated that, foregoing request unit 802, parsing unit 804 and encapsulation unit 806 of the present application provide an optional solution of generating a debug bridge data packet by the debug bridge executable program. A service request is initiated on the basis of request unit 802, a service data packet is generated by using parsing unit 804, and the service data is encapsulated into a debug bridge data packet in the form of a transmission protocol packet by means of encapsulation unit 806.

It is appreciated that, foregoing request unit 802, parsing unit 804 and encapsulation unit 806 correspond to step S3022 to step S3026 with reference to FIG. 3. Implemented examples and application scenarios of the three modules can be same or similar as those of the corresponding steps, but are not limited to the content disclosed in FIG. 3. It should be noted that the foregoing modules, as a part of the apparatus, may run in computer terminal 10 provided in FIG. 2, and may be implemented by software or implemented by hardware.

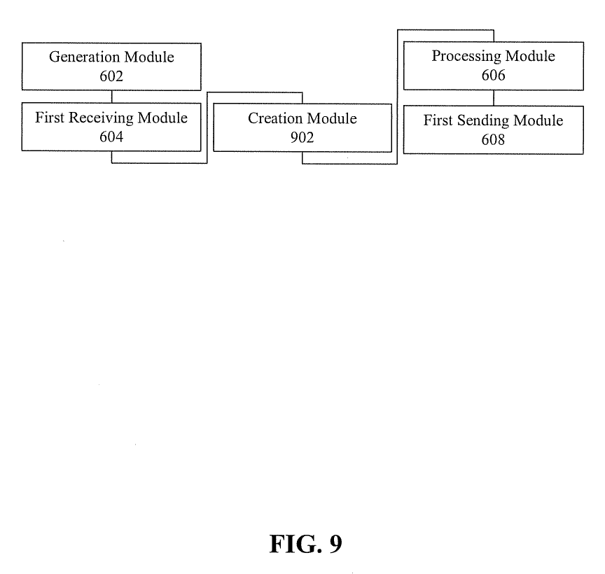

Optionally, FIG. 9 is a schematic structural diagram of another optional virtual machine-based data transmission apparatus according to embodiments shown in FIG. 6 of the present application. As shown in FIG. 9, the virtual machine-based data transmission apparatus according to embodiments of the present application further includes: a creation module 902 configured to enable the virtual host to pre-create the virtual storage device locally and create a first cache region locally, wherein the first cache region is used for caching the debug bridge data packet.

It is appreciated that, foregoing creation module 902 corresponds to step S303 in FIG. 3. An implemented example and an application scenario of the module are the same as those of the corresponding step, but are not limited to the content disclosed in FIG. 3. It should be noted that the foregoing module, as a part of the apparatus, may run in the computer terminal 10 provided in FIG. 2, and may be implemented by software or implemented by hardware.

The implementation solution provided in FIG. 6 of the present application has the same or similar optional solutions and application scenario implementation process as the method embodiment provided in FIG. 3, but is not limited to the solution provided in FIG. 3.

A virtual machine-based data transmission apparatus for implementing the foregoing virtual machine-based data transmission method is further provided according to embodiments of the present application. The apparatus provided in the embodiments of the present application may run on a computer terminal.

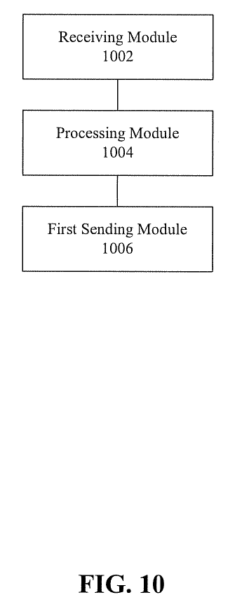

FIG. 10 is a schematic structural diagram of a virtual machine-based data transmission apparatus according to embodiments of the present application. As shown in FIG. 10, the apparatus includes: a receiving module 1002, a processing module 1004 and a first sending module 1006.

Receiving module 1002 can be configured to enable an intermediate terminal device installed with a virtual client to receive a debug bridge service data packet transmitted by a target terminal device. The target terminal device generates the debug bridge service data packet by using a debug bridge daemon process, and transmits the debug bridge service data packet to the virtual client through a storage device.

Processing module 1004 can be configured to enable the virtual client to cache the debug bridge service data packet and generate first feedback information.

First sending module 1006 can be configured to enable the virtual client to return the first feedback information to the debug bridge daemon process and start the debug bridge daemon process to send a newly generated debug bridge service data packet.

The debug bridge service data packet is remotely transmitted by the intermediate terminal device to a service terminal device.

It is appreciated that, foregoing receiving module 1002, processing module 1004 and first sending module 1006 of the present application provide an optional solution for data transmission between the virtual client and the debug bridge daemon process in the target terminal device. An immediate feedback reply function is implemented in the virtual client added in the intermediate terminal device to improve data transmission efficiency. First, the virtual client caches a debug bridge reply data packet locally upon receipt of the debug bridge reply data packet, and returns feedback reply information for the debug bridge reply data packet to the debug bridge daemon process running in the target terminal device. After receiving the feedback reply information, the debug bridge daemon process can determine that the currently sent debug bridge reply data packet has been sent successfully, and therefore sends a next debug bridge reply data packet. Thus, the efficiency of sending the debug bridge reply data packet of the debug bridge daemon process can be improved, thereby implementing rapid uplink transmission of debug bridge reply data in the target terminal device to the service terminal device. A data exchange rate between the debug bridge executable program in the remote system and the debug bridge daemon process in the target terminal device can be improved, thereby solving the technical problem that management efficiency of an Android device is low a remote system due to a low transmission rate during storage device virtualization in a debug bridge mode.

It is appreciated that, foregoing receiving module 1002, processing module 1004 and first sending module 1006 correspond to step S502 to step S506 of FIG. 5. Implemented examples and application scenarios of the three modules are the same as those of the corresponding steps, but are not limited to the content of FIG. 3. It should be noted that the foregoing modules, as a part of the apparatus, may run in computer terminal 10 of FIG. 2, and may be implemented by software or implemented by hardware.

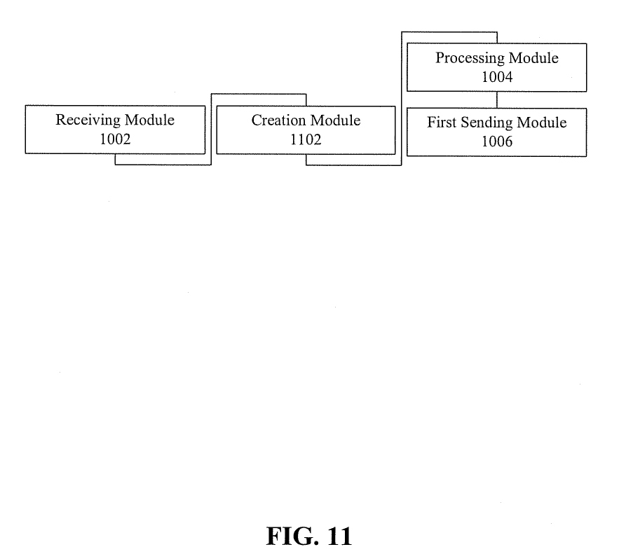

Optionally, FIG. 11 is a schematic structural diagram of an optional virtual machine-based data transmission apparatus according to the embodiment shown in FIG. 10 of the present application. As shown in FIG. 11, the virtual machine-based data transmission apparatus according to embodiments of the present application further includes: a creation module 1102 configured to enable the virtual client to create a cache region locally. The cache region is used for caching the debug bridge service data packet.

In the foregoing optional solution of the present application, an optional manner of caching the debug bridge service data packet by the virtual client is: creating a cache region, such as a cache pool, for a debug bridge device, to cache the debug bridge service data packet that is transmitted uplink by the debug bridge daemon process to the debug bridge executable program.

It is appreciated that, in the current USB virtualization solution, the ADB of an Android phone is redirected to a virtual machine for use, and the speed thereof is only at a KB level. When software such as a mobile phone assistant is used in the virtual machine to carry out management, the delay is very significant and the user experience is rather poor. Therefore, the solution provided in embodiments of the present application designs a set of cache mechanisms for USB virtualization transmission of the ADB, i.e., a cache pool for caching ADB service data packets is implemented in the virtual client of the intermediate terminal device. Inside the intermediate terminal device, an ADB service data packet is acquired in advance by returning first feedback information through a physical USB interface, and is filled into the cache pool, so that the transmission speed can be increased from the KB level to the MB level.

It is appreciated that, foregoing creation module 1102 corresponds to the step of creating a cache region locally by the virtual client. An implemented example and an application scenario of the module are the same as those of the corresponding step, but are not limited to the content. It should be noted that the foregoing module, as a part of the apparatus, may run in computer terminal 10 of FIG. 2, and may be implemented by software or implemented by hardware.

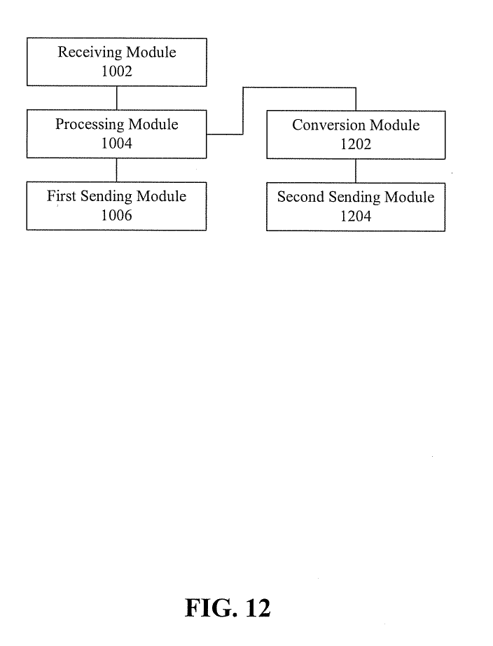

Optionally, FIG. 12 is a schematic structural diagram of another optional virtual machine-based data transmission apparatus according to the embodiment shown in FIG. 10 of the present application. As shown in FIG. 12, the virtual machine-based data transmission apparatus according to embodiments of the present application further includes: a conversion module 1202 and a second sending module 1204.

Conversion module 1202 can be configured to enable the virtual client to convert the debug bridge service data packet into a virtual service data packet.

Second sending module 1204 can be configured to enable the virtual client to transmit the virtual service data packet to the service terminal device installed with a virtual host.

After the virtual host obtains the debug bridge service data packet by parsing the virtual service data packet, the debug bridge service data packet is sent, through a virtual storage device pre-created by the virtual host, to a debug bridge executable program running on the service terminal device.

It is appreciated that, foregoing conversion module 1202 and second sending module 1204 of the present application provide an optional solution of sending, by the intermediate terminal device, the cached debug bridge reply data packet to the debug bridge executable program. The debug bridge reply data packet is converted into a virtual reply data packet on the basis of step S412, and the virtual reply data packet is transmitted to the service terminal device by performing step S414, thus finally implementing transmission of the debug bridge reply data packet to the debug bridge executable program.

It is appreciated that, foregoing conversion module 1202 and second sending module 1204 correspond to step S512 to step S514. Implemented examples and application scenarios of the two modules are the same as those of the corresponding steps, but are not limited to the content. It should be noted that the foregoing modules, as a part of the apparatus, may run in computer terminal 10 of FIG. 2, and may be implemented by software or implemented by hardware.

The preferred implementation solution provided in FIG. 10 of the present application has the same optional solutions and application scenario implementation process as the method embodiment provided with reference to FIG. 5, but is not limited to the solution provided by FIG. 5.

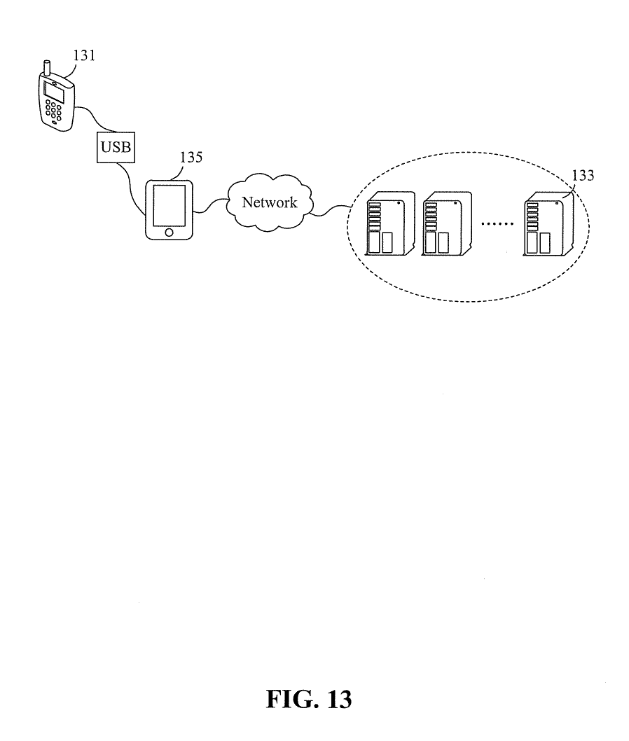

A virtual machine-based data transmission system is further provided according to the embodiments of the present application. FIG. 13 is a schematic structural diagram of a virtual machine-based data transmission system according to some embodiments of the present application.

As shown in FIG. 13, the virtual machine-based data transmission system includes: a target terminal device 131, a service terminal device 133 and an intermediate terminal device 135.

Service terminal device 133 is installed with a debug bridge executable program and a virtual host, and is configured to: after the virtual host receives and caches a debug bridge data packet generated by the debug bridge executable program, convert the debug bridge data packet into a virtual data packet and generate feedback information, and meanwhile return the feedback information to the debug bridge executable program, such that the debug bridge executable program continues to send a newly generated debug bridge data packet to the virtual host.

Intermediate terminal device 135 is installed with a virtual client, is connected to the service terminal device through a network and connected to the target terminal device through a storage device, and is configured to: receive a debug bridge reply data packet generated, according to the debug bridge data packet, by a debug bridge daemon process running on the target terminal device, wherein after the virtual client caches the debug bridge reply data packet and generates feedback reply information, the virtual client returns the feedback reply information to the debug bridge daemon process, such that the debug bridge daemon process continues to send a newly generated debug bridge reply data packet to the virtual client.

The service terminal device remotely transmits the debug bridge data packet to the target terminal device through the intermediate terminal device, and the target terminal device also remotely transmits the debug bridge reply data packet to the service terminal device through the intermediate terminal device.

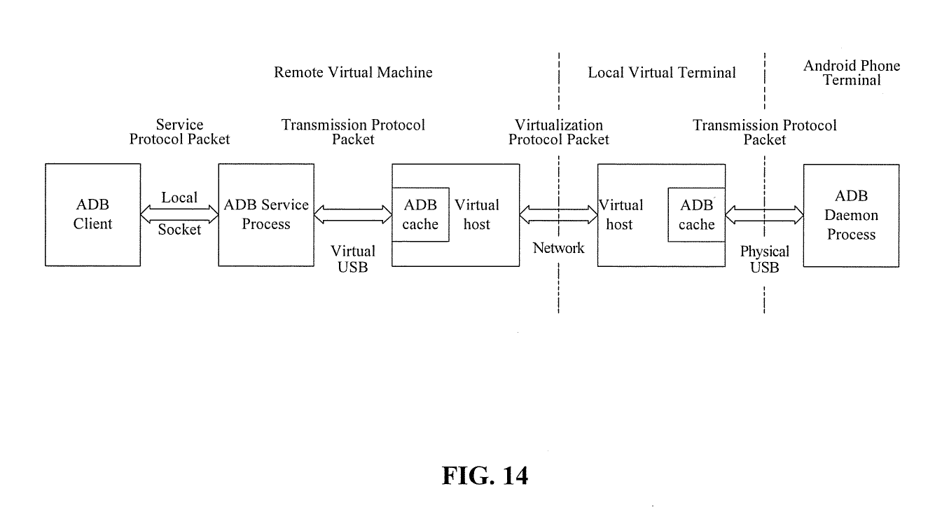

FIG. 14 is an implementation architectural diagram of an optional virtual machine-based data transmission system according to some embodiments of the present application. The virtual machine-based data transmission system of the present application is described by using an example in which the target terminal device 131 is an Android phone terminal, the service terminal device 133 is a remote virtual machine, and the intermediate terminal device 135 is a local virtual terminal.

As shown in FIG. 14, in the remote virtual machine, a virtual host is added, wherein the virtual host runs in the remote virtual machine. The main function of the virtual host is parsing and processing a USB virtualization protocol on a network, and creating and managing a virtual USB device. In addition, for an ADB device, an ADB cache pool may be created to cache downlink the ADB transmission protocol packets of an ADB server.

In the local virtual terminal, a virtual client is added, wherein the virtual client runs in the local virtual terminal. The main function of the virtual client is parsing and processing the USB virtualization protocol on the network, monitoring an inserted USB physical device, and initiating and managing a virtual USB device. In addition, for an ADB device, an ADB cache pool may be created to cache uplink ADB transmission protocol packets of an ADB daemon.

Based on the foregoing system, a data procedure of sending ADB data from the remote virtual machine downlink to the Android phone terminal is as follows:

1) An ADB client initiates a service request to an ADB server, wherein the ADB client may also be referred to as an ADB client terminal in embodiments of the present application, and the ADB server may also be referred to as an ADB service process in embodiments of the present application.

2) After obtaining the service packet through parsing, the ADB server encapsulates the service packet into an ADB transmission protocol packet, and sends the ADB transmission protocol packet to a virtual host through a virtual ADB USB device.

3) Upon receipt of the ADB transmission protocol packet on the virtual USB device, the virtual host fills the packet into a local cache region, e.g., an ADB cache, and generates feedback information to notify the ADB server that transmission of this downlink packet has been completed, such that the ADB server can initiate a next downlink ADB transmission protocol packet.

4) The virtual host further encapsulates the downlink ADB transmission protocol packet in the ADB cache into a USB virtualization protocol packet and sends the packet to a virtual client through a network.

5) After parsing the content of the virtualization protocol packet, the virtual client transmits the content therein, e.g., the ADB transmission packet, to an ADB daemon process (ADB daemon) through a USB physical device, thus completing the whole downlink sending.

Based on the foregoing system, a data procedure of sending ADB data from the Android phone terminal uplink to the remote virtual machine is as follows:

1) The ADB daemon process (ADB daemon) encapsulates a service reply packet into an ADB transmission protocol packet and sends the packet to the physical USB device.

2) Upon receipt of the ADB transmission protocol packet on the physical USB device, the virtual client fills the packet into a local ADB cache, and notifies the ADB daemon that transmission of this uplink packet has been completed, such that the ADB daemon can initiate a next uplink ADB transmission protocol packet.

3) The virtual client further encapsulates the uplink ADB transmission protocol packet in the ADB cache into a USB virtualization protocol packet and sends the packet to the virtual host through the network.

4) After parsing the content of the virtualization protocol packet, the virtual host transmits the content therein, e.g., the ADB transmission packet, to the ADB server through the virtual USB physical device.

5) The ADB server then parses the received ADB transmission packet, encapsulates it into a service packet, and sends the service packet to the ADB client, thus completing the whole uplink sending.

The implementation solution provided by the virtual machine-based data transmission system of the present application is the same or similar as the optional solutions and application scenario implementation processes provided above, but are not limited to the solutions provided in above embodiments.

It is appreciated that, virtual machine-based data transmission system provides a system-level solution. An immediate feedback reply function is implemented in a virtual host added in a service terminal device to improve data transmission efficiency. First, the virtual host caches a debug bridge data packet locally upon receipt of the debug bridge data packet, and returns feedback information for the debug bridge data packet to a debug bridge executable program that runs on the service terminal device locally. After receiving the feedback information, the debug bridge executable program can determine that the currently sent debug bridge data packet has been sent successfully, and therefore sends a next debug bridge data packet, thus achieving an objective of improving debug bridge data packet sending efficiency of the debug bridge executable program, thereby implementing rapid downlink transmission of debug bridge data in the service terminal device to a target terminal device. An immediate feedback reply function is implemented in a virtual client added in an intermediate terminal device to improve data transmission efficiency. First, the virtual client caches a debug bridge reply data packet locally upon receipt of the debug bridge reply data packet, and returns feedback reply information for the debug bridge reply data packet to a debug bridge daemon process running in the target terminal device. After receiving the feedback reply information, the debug ridge daemon process can determine that the currently sent debug bridge reply data packet has been sent successfully, and therefore sends a next debug bridge reply data packet. Thus, the efficiency of sending the debug bridge reply data packet of the debug bridge daemon process can be improved, thereby implementing rapid uplink transmission of debug bridge reply data in the target terminal device to the service terminal device. A data exchange rate between the debug bridge executable program in a virtual desktop and the debug bridge daemon process in the target terminal device can be improved, thereby solving the technical problem that management efficiency of an Android device is low in a remote system due to a low transmission rate during storage device virtualization in a debug bridge mode.

Embodiments of the present application may provide a computer terminal. The computer terminal may be any computer terminal device in a computer terminal group. Optionally, in some embodiments, the computer terminal may also be replaced with a terminal device such as a mobile terminal.

Optionally, in some embodiments, the computer terminal may be at least one network device of multiple network devices located in a computer network.

In some embodiments, the computer terminal may execute program code of the following steps in an application program vulnerability detection method: generating, by a debug bridge executable program running in a service terminal device, a debug bridge data packet; receiving, by a virtual host running on the service terminal device, the debug bridge data packet through a pre-created virtual storage device; caching, by the virtual host, the debug bridge data packet, and generating feedback information; and returning, by the virtual host, the feedback information to the debug bridge executable program, such that the debug bridge executable program sends a newly generated debug bridge data packet to the virtual host, wherein the debug bridge data packet is remotely transmitted by the service terminal device to a target terminal device.

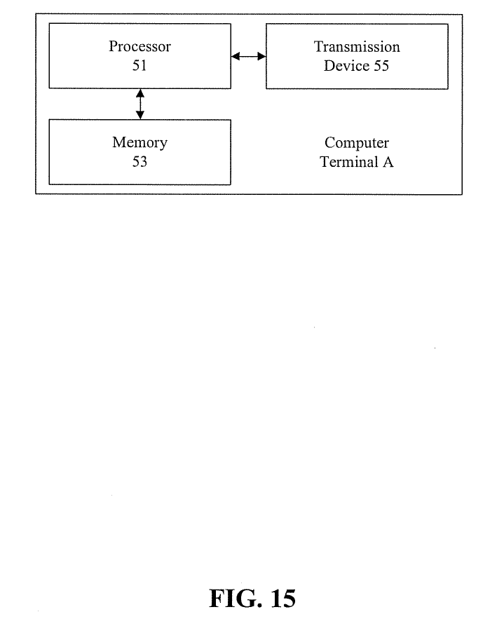

Optionally, FIG. 15 is a structural block diagram of a computer terminal according to embodiments of the present application. As shown in FIG. 15, the computer terminal A may include: one or more (only one is shown in the figure) processors 51, a memory 53 and a transmission device 55.

Memory 53 may be configured to store software programs and modules, such as program instructions/modules corresponding to the security vulnerability detection method and apparatus in the embodiments of the present application. Processor 51 performs various functional applications and data processing by running the software programs and modules stored in memory 53, e.g., implements the foregoing method for detecting system vulnerability attacks. Memory 53 may include a high-speed random access memory, and may further include a non-volatile memory, such as one or more magnetic storage apparatuses, a flash memory, or another non-volatile solid-state memory. In some examples, memory 53 may further include memories remotely set with respect to processor 51, and these remote memories may be connected to the terminal A through a network. Examples of the network include, but are not limited to, the Internet, an intranet, a local area network, a mobile communications network and a combination thereof.

Transmission device 55 is configured to send or receive data through a network. Examples of the network may include a wired network and a wireless network. In an example, transmission device 55 includes a Network Interface Controller (NIC), which may be connected to another network device and a router through a cable, thereby communicating with the Internet or a local area network. In an example, transmission device 55 is a Radio Frequency (RF) module, which is configured to communicate with the Internet in a wireless manner.

Memory 53 can be configured to store information of a preset action condition and a preset privileged user, and an application program.

Processor 51 may invoke, by using the transmission apparatus, the information and application program stored in memory 53 to perform the following steps: generating, by a debug bridge executable program running in a service terminal device, a debug bridge data packet; receiving, by a virtual host running on the service terminal device, the debug bridge data packet through a pre-created virtual storage device; caching, by the virtual host, the debug bridge data packet, and generating feedback information; and returning, by the virtual host, the feedback information to the debug bridge executable program, such that the debug bridge executable program sends a newly generated debug bridge data packet to the virtual host, wherein the debug bridge data packet is remotely transmitted by the service terminal device to a target terminal device.

Optionally, processor 51 may further execute program code of the following steps: converting, by the virtual host, the debug bridge data packet into a virtual data packet; and transmitting, by the virtual host, the virtual data packet to an intermediate terminal device installed with a virtual client, wherein after the virtual client obtains the debug bridge data packet by parsing the virtual data packet, the debug bridge data packet is sent to the target terminal device through a storage device interface of the intermediate tenninal device, and the target terminal device accesses the intermediate terminal device through a storage device.

Optionally, processor 51 may further execute program code of the following steps: generating, by a debug bridge daemon process running on the target tenninal device, a debug bridge reply data packet according to the debug bridge data packet; transmitting, by the debug bridge daemon process, the debug bridge reply data packet to the virtual client through the storage device; caching, by the virtual client, the debug bridge reply data packet, and generating feedback reply information; and returning, by the virtual client, the feedback reply information to the debug bridge daemon process, and starting the debug bridge daemon process to send a newly generated debug bridge reply data packet.

Optionally, processor 51 may further execute program code of the following step: creating, by the virtual client, a second cache region locally, wherein the second cache region is used for caching the debug bridge reply data packet.

Optionally, processor 51 may further execute program code of the following steps: converting, by the virtual client, the debug bridge reply data packet into a virtual reply data packet; and transmitting, by the virtual client, the virtual reply data packet to the service terminal device installed with the virtual host, wherein after the virtual host obtains the debug bridge reply data packet by parsing the virtual reply data packet, the debug bridge reply data packet is sent to the debug bridge executable program through the virtual storage device.

Optionally, processor 51 may further execute program code of the following steps: sequentially making, by the intermediate terminal device, timestamps on the generated multiple debug bridge data packets; hashing the multiple debug bridge data packets with the timestamps into data packets in a cache queue; and sorting and/or screening the data packets in the cache queue, and sending the data packets in the cache queue to the target terminal device according to a preset transmission strategy, wherein the transmission strategy is used for representing transmission priorities of the data packets in the cache queue.

Optionally, processor 51 may further execute program code of the following steps: initiating, by the debug bridge client running in the service terminal device, a service request to the debug bridge service process; parsing, by the debug bridge service process, the service request to generate a service data packet; and encapsulating, by the debug bridge service process, the service data packet according to a debug bridge transmission protocol to generate the debug bridge data packet.

Optionally, processor 51 may further execute program code of the following step: pre-creating, by the virtual host, the virtual storage device locally, and creating a first cache region locally, wherein the first cache region is used for caching the debug bridge data packet.

Embodiments of the present application provide a virtual machine-based data transmission control solution. An immediate feedback reply function is implemented in a virtual host added in a service terminal device to improve data transmission efficiency. First, the virtual host caches a debug bridge data packet locally upon receipt of the debug bridge data packet, and returns feedback information for the debug bridge data packet to a debug bridge executable program that runs on the service terminal device locally. After receiving the feedback information, the debug bridge executable program can determine that the currently sent debug bridge data packet has been sent successfully, and therefore sends a next debug bridge data packet, thus achieving an objective of improving debug bridge data packet sending efficiency of the debug bridge executable program, thereby implementing rapid downlink transmission of debug bridge data in the service terminal device to a target terminal device. The foregoing solution achieves a technical effect of improving a data exchange rate between the debug bridge executable program in a virtual desktop and a debug bridge daemon process in the target terminal device, thereby solving the technical problem in the prior art that management efficiency of an Android device is low in a remote system due to a low transmission rate during storage device virtualization in a debug bridge mode.

It is appreciated that the structure shown in FIG. 15 is merely an example. The computer terminal may also be a smart phone (such as an Android phone or an iOS phone), a tablet computer, a palmtop computer, Mobile Internet Devices (MIDs), PAD, and other terminal devices. FIG. 15 does not limit the structure of the foregoing electronic device. For example, the computer terminal A may also include components (such as a network interface and a display apparatus) more or fewer than those shown in FIG. 15, or has a configuration different from that shown in FIG. 15.

It is appreciated that all or some steps in various methods of the foregoing embodiments may be completed by a program instructing relevant hardware of a terminal device. The program may be stored in a computer readable storage medium, and the storage medium may include: a flash memory disk, a Read-Only Memory (ROM), a Random Access Memory (RAM), a magnetic disk, an optical disc, etc.

Embodiments of the present application may provide a computer terminal. The computer terminal may be any computer terminal device in a computer terminal group. Optionally, in some embodiments, the computer terminal may also be replaced with a terminal device such as a mobile terminal.

Optionally, in some embodiments, the computer terminal may be at least one network device of multiple network devices located in a computer network.

In some embodiments, the computer terminal may execute program code of the following steps in an application program vulnerability detection method: generating, by a debug bridge executable program running in a service terminal device, a debug bridge data packet; receiving, by a virtual host running on the service terminal device, the debug bridge data packet through a pre-created virtual storage device; caching, by the virtual host, the debug bridge data packet, and generating feedback information; and returning, by the virtual host, the feedback information to the debug bridge executable program, such that the debug bridge executable program sends a newly generated debug bridge data packet to the virtual host, wherein the debug bridge data packet is remotely transmitted by the service terminal device to a target terminal device.

Optionally, the structural block diagram of a computer terminal provided in FIG. 15 can be further referred. As shown in FIG. 15, the computer terminal A may include: one or more (only one is shown in the figure) processors 51, a memory 53 and a transmission device 55.

Wherein memory 53 may be configured to store software programs and modules, such as program instructions/modules corresponding to the security vulnerability detection method and apparatus in embodiments of the present application. Processor 51 performs various functional applications and data processing by running the software programs and modules stored in memory 53, i.e., implements the foregoing method for detecting system vulnerability attacks. Memory 53 may include a high-speed random access memory, and may further include a non-volatile memory, such as one or more magnetic storage apparatuses, a flash memory, or another non-volatile solid-state memory. In some examples, memory 53 may further include memories remotely set with respect to processor 51, and these remote memories may be connected to the terminal A through a network. Examples of the network include, but are not limited to, the Internet, an intranet, a local area network, a mobile communications network and a combination thereof.

Transmission device 55 is configured to send or receive data through a network. Examples of the network may include a wired network and a wireless network. In an example, transmission device 55 includes a Network Interface Controller (NIC), which may be connected to another network device and a router through a cable, thereby communicating with the Internet or a local area network. In an example, transmission device 55 is a Radio Frequency (RF) module, which is configured to communicate with the Internet in a wireless manner.

Memory 53 can be further configured to store information about a preset action condition and a preset privileged user, and an application program.

Processor 51 may invoke, by using the transmission apparatus, the information and application program stored in memory 53 to perform the following steps: receiving, by an intermediate terminal device installed with a virtual client, a debug bridge service data packet transmitted by a target terminal device, wherein the target terminal device generates the debug bridge service data packet by using a debug bridge daemon process, and transmits the debug bridge service data packet to the virtual client through a storage device; caching, by the virtual client, the debug bridge service data packet, and generating first feedback information; and returning, by the virtual client, the first feedback information to the debug bridge daemon process, and starting the debug bridge daemon process to send a newly generated debug bridge service data packet, wherein the debug bridge service data packet is remotely transmitted by the intermediate terminal device to a service terminal device.

Optionally, processor 51 may further execute program code of the following step: creating, by the virtual client, a cache region locally, wherein the cache region is used for caching the debug bridge service data packet.

Optionally, processor 51 may further execute program code of the following steps: converting, by the virtual client, the debug bridge service data packet into a virtual service data packet; and transmitting, by the virtual client, the virtual service data packet to the service terminal device installed with a virtual host, wherein after the virtual host obtains the debug bridge service data packet by parsing the virtual service data packet, the debug bridge service data packet is sent, through a virtual storage device pre-created by the virtual host, to a debug bridge executable program running on the service terminal device.

Optionally, processor 51 may further execute program code of the following steps: parsing, by the debug bridge service process running in the service terminal device, the debug bridge service data packet; encapsulating, by the debug bridge service process, the parsed debug bridge service data packet to generate a service-type data packet; and sending, by the debug bridge service process, the generated service-type data packet to the debug bridge client.

Embodiments of the present application provide a virtual machine-based data transmission control solution. An immediate feedback reply function is implemented in a virtual client added in an intermediate terminal device to improve data transmission efficiency. First, the virtual client caches a debug bridge reply data packet locally upon receipt of the debug bridge reply data packet, and returns feedback reply information for the debug bridge reply data packet to a debug bridge daemon process running in a target terminal device. After receiving the feedback reply information, the debug bridge daemon process can determine that the currently sent debug bridge reply data packet has been sent successfully, and therefore sends a next debug bridge reply data packet, thus achieving an objective of improving debug bridge reply data packet sending efficiency of the debug bridge daemon process, thereby implementing rapid uplink transmission of debug bridge reply data in the target terminal device to a service terminal device. The foregoing solution achieves a technical effect of improving a data exchange rate between a debug bridge executable program in a remote system and the debug bridge daemon process in the target terminal device, thereby solving the technical problem in the prior art that management efficiency of an Android device is low in a remote system due to a low transmission rate during storage device virtualization in a debug bridge mode.

It is appreciated that, the structure shown in FIG. 15 is merely an example. The computer terminal may also be a smart phone (such as an Android phone or an iOS phone), a tablet computer, a palmtop computer, Mobile Internet Devices (MIDs), PAD, and other terminal devices. FIG. 15 does not limit the structure of the foregoing electronic device. For example, the computer terminal A may also include components (such as a network interface and a display apparatus) more or fewer than those shown in FIG. 15, or has a configuration different from that shown in FIG. 15.

It is appreciated that, all or some steps in various methods of the foregoing embodiments may be completed by a program instructing relevant hardware of a terminal device. The program may be stored in a non-transitory computer readable storage medium, and the non-transitory computer readable storage medium may include: a flash memory disk, a Read-Only Memory (ROM), a Random Access Memory (RAM), a magnetic disk, an optical disc, etc.

Embodiments of the present application further provide a storage medium. Optionally, in some embodiments, the storage medium may be configured to store program code executed by the virtual machine-based data transmission method provided above with respect to FIG. 2.

Optionally, in some embodiments, the storage medium may be located in any computer terminal in a computer terminal group in a computer network, or located in any mobile terminal in a mobile terminal group.

Optionally, in some embodiments, the storage medium is configured to store program code for performing the following steps: generating, by a debug bridge executable program running in a service terminal device, a debug bridge data packet; receiving, by a virtual host running on the service terminal device, the debug bridge data packet through a pre-created virtual storage device; caching, by the virtual host, the debug bridge data packet, and generating feedback information; and returning, by the virtual host, the feedback information to the debug bridge executable program, such that the debug bridge executable program sends a newly generated debug bridge data packet to the virtual host, wherein the debug bridge data packet is remotely transmitted by the service terminal device to a target terminal device.

Optionally, the storage medium is further configured to store program code for performing the following steps: converting, by the virtual host, the debug bridge data packet into a virtual data packet; and transmitting, by the virtual host, the virtual data packet to an intermediate terminal device installed with a virtual client, wherein after the virtual client obtains the debug bridge data packet by parsing the virtual data packet, the debug bridge data packet is sent to the target terminal device through a storage device interface of the intermediate terminal device, and the target terminal device accesses the intermediate terminal device through a storage device.

Optionally, the storage medium is further configured to store program code for performing the following steps: generating, by a debug bridge daemon process running on the target terminal device, a debug bridge reply data packet according to the debug bridge data packet; transmitting, by the debug bridge daemon process, the debug bridge reply data packet to the virtual client through the storage device; caching, by the virtual client, the debug bridge reply data packet, and generating feedback reply information; and returning, by the virtual client, the feedback reply information to the debug bridge daemon process, and starting the debug bridge daemon process to send a newly generated debug bridge reply data packet.

Optionally, the storage medium is further configured to store program code for performing the following step: creating, by the virtual client, a second cache region locally, wherein the second cache region is used for caching the debug bridge reply data packet.

Optionally, the storage medium is further configured to store program code for performing the following steps: converting, by the virtual client, the debug bridge reply data packet into a virtual reply data packet; and transmitting, by the virtual client, the virtual reply data packet to the service terminal device installed with the virtual host, wherein after the virtual host obtains the debug bridge reply data packet by parsing the virtual reply data packet, the debug bridge reply data packet is sent to the debug bridge executable program through the virtual storage device.

Optionally, the storage medium is further configured to store program code for performing the following steps: sequentially making, by the intermediate terminal device, timestamps on the generated multiple debug bridge data packets; hashing the multiple debug bridge data packets with the timestamps into data packets in a cache queue; and sorting and/or screening the data packets in the cache queue, and sending the data packets in the cache queue to the target terminal device according to a preset transmission strategy, wherein the transmission strategy is used for representing transmission priorities of the data packets in the cache queue.

Optionally, the storage medium is further configured to store program code for performing the following steps: initiating, by the debug bridge client running in the service terminal device, a service request to the debug bridge service process; parsing, by the debug bridge service process, the service request to generate a service data packet; and encapsulating, by the debug bridge service process, the service data packet according to a debug bridge transmission protocol to generate the debug bridge data packet.

Optionally, the storage medium is further configured to store program code for performing the following step: pre-creating, by the virtual host, the virtual storage device locally, and creating a first cache region locally, wherein the first cache region is used for caching the debug bridge data packet.

It is appreciated that any computer terminal in the computer terminal group may establish a communication relationship with a web server and a scanner. The scanner may scan value commands of a web application program executed by PHP on the computer terminal.

Embodiments of the present application further provides a storage medium. Optionally, in some embodiments, the storage medium may be configured to store program code executed by the virtual machine-based data transmission method provided above with respect to FIG. 5.

Optionally, in some embodiments, the storage medium may be located in any computer terminal in a computer terminal group in a computer network, or located in any mobile terminal in a mobile terminal group.

Optionally, in some embodiments, the storage medium is configured to store program code for performing the following steps: receiving, by an intermediate terminal device installed with a virtual client, a debug bridge service data packet transmitted by a target terminal device, wherein the target terminal device generates the debug bridge service data packet by using a debug bridge daemon process, and transmits the debug bridge service data packet to the virtual client through a storage device; caching, by the virtual client, the debug bridge service data packet, and generating first feedback information; and returning, by the virtual client, the first feedback information to the debug bridge daemon process, and starting the debug bridge daemon process to send a newly generated debug bridge service data packet, wherein the debug bridge service data packet is remotely transmitted by the intermediate terminal device to a service terminal device.

Optionally, the storage medium is further configured to store program code for performing the following step: creating, by the virtual client, a cache region locally, wherein the cache region is used for caching the debug bridge service data packet.

Optionally, the storage medium is further configured to store program code for performing the following steps: converting, by the virtual client, the debug bridge service data packet into a virtual service data packet; and transmitting, by the virtual client, the virtual service data packet to the service terminal device installed with a virtual host, wherein after the virtual host obtains the debug bridge service data packet by parsing the virtual service data packet, the debug bridge service data packet is sent, through a virtual storage device pre-created by the virtual host, to a debug bridge executable program running on the service terminal device.

Optionally, the storage medium is further configured to store program code for performing the following steps: parsing, by the debug bridge service process running in the service terminal device, the debug bridge service data packet; encapsulating, by the debug bridge service process, the parsed debug bridge service data packet to generate a service-type data packet; and sending, by the debug bridge service process, the generated service-type data packet to the debug bridge client.

It is appreciated that any computer terminal in the computer terminal group may establish a communication relationship with a web server and a scanner. The scanner may scan value commands of a web application program executed by PHP on the computer terminal.

The serial numbers of the foregoing embodiments of the present application are merely used for description, and do not imply any preference among the embodiments.

In the foregoing embodiments of the present application, the descriptions of each embodiment have their respective focuses. For a part that is not described in detail in an embodiment, reference may be made to related descriptions in other embodiments.

In the several embodiments provided in the present application, it should be understood that the disclosed client may be implemented in other manners. The apparatus embodiment described above is merely schematic. For example, the unit division is merely logical function division, and there may be other division manners in actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between units or modules may be implemented in an electronic form or other forms.

The units described as separate parts may or may not be physically separate, and the parts displayed as units may or may not be physical units, that is, they may be located in one position, or may be distributed on a plurality of network units. Some or all the units therein may be selected according to actual needs to achieve the objectives of the solution of the embodiment.

In addition, functional units in the embodiments of the present application may be integrated into one processing unit, or each of the units may exist alone physically, or two or more units are integrated into one unit. The integrated unit may be implemented in the form of hardware, or may be implemented in the form of a software function unit.

When the integrated unit is implemented in the form of a software functional unit and sold or used as an independent product, the integrated unit may be stored in a computer readable storage medium. Based on such understanding, the technical solutions of the present application essentially, or the part making contributions to the prior art, or some or all the technical solutions may be implemented in the form of a software product. The computer software product may be stored in a storage medium, including several instructions for instructing a computer device (which may be a personal computer, a server, a network device, etc.) to execute all or some steps of the methods of embodiments of the present application. The foregoing storage medium includes any medium that can store program code, such as a USB flash drive, a Read-Only Memory (ROM), a Random Access Memory (RAM), a mobile hard disk drive, a magnetic disk, or an optical disc.

Described above are merely preferred implementations of the present application. It should be noted that those of ordinary skill in the art may further make a number of improvements or modifications without departing from the principle of the present application, and these improvements and modifications should also be construed as the protection scope of the present application.

1. A virtual machine-based data transmission method, comprising:
receiving, by a virtual host of a service terminal device, a debug bridge data packet through a pre-created virtual storage device, wherein the debug bridge data packet is generated by a debug bridge executable program of the service terminal device;
caching, by the virtual host, the debug bridge data packet to generate feedback information; and
returning, by the virtual host, the feedback information to the debug bridge executable program, such that the debug bridge executable program sends a newly generated debug bridge data packet to the virtual host,
wherein the debug bridge data packet is transmitted by the service terminal device to a target terminal device.

2. The method according to claim 1, wherein after caching, by the virtual host, the debug bridge data packet, the method further comprises:
converting, by the virtual host, the debug bridge data packet into a virtual data packet; and
transmitting, by the virtual host, the virtual data packet to an intermediate terminal device installed with a virtual client,
wherein after the virtual client obtains the debug bridge data packet by parsing the virtual data packet, the debug bridge data packet is sent to the target terminal device through a storage device interface of the intermediate terminal device, and the target terminal device accesses the intermediate terminal device through a storage device.

3. The method according to claim 2, wherein after the target terminal device receives the debug bridge data packet transmitted by the service terminal device, the method further comprises:
generating, by a debug bridge daemon process of the target terminal device, a debug bridge reply data packet according to the debug bridge data packet;
transmitting, by the debug bridge daemon process, the debug bridge reply data packet to the virtual client through the storage device;
caching, by the virtual client, the debug bridge reply data packet to generate feedback reply information; and
returning, by the virtual client, the feedback reply info' nation to the debug bridge daemon process to send a newly generated debug bridge reply data packet.

4. The method according to claim 3, wherein the virtual client creates a second cache region, and the second cache region is configured for caching the debug bridge reply data packet.

5. The method according to claim 3, wherein after caching, by the virtual client, the debug bridge reply data packet, the method further comprises:
converting, by the virtual client, the debug bridge reply data packet into a virtual reply data packet; and
transmitting, by the virtual client, the virtual reply data packet to the service terminal device installed with the virtual host,
wherein after the virtual host obtains the debug bridge reply data packet by parsing the virtual reply data packet, the debug bridge reply data packet is sent to the debug bridge executable program through the virtual storage device.

6. The method according to claim 2, wherein transmitting, by the virtual host, the virtual data packet to an intermediate terminal device installed with a virtual client comprises:
sequentially attaching, by the virtual host, timestamps on multiple virtual data packets;
hashing the multiple virtual data packets with the timestamps into data packets in a cache queue; and
sending the data packets in the cache queue to the target terminal device according to a preset transmission strategy, wherein the transmission strategy is associated with transmission priorities of the data packets in the cache queue.

7. The method according to claim 1, wherein the debug bridge executable program at least includes: a debug bridge client and a debug bridge service process, and the generation of the debug bridge data packet further comprises:
initiating, by the debug bridge client, a service request to the debug bridge service process;
parsing, by the debug bridge service process, the service request to generate a service data packet; and
encapsulating, by the debug bridge service process, the service data packet according to a debug bridge transmission protocol to generate the debug bridge data packet.

8. The method according to claim 1, wherein before receiving, by a virtual host running on the service terminal device, the debug bridge data packet through a pre-created virtual storage device, the method further comprises:
pre-creating, by the virtual host, the virtual storage device; and
creating a first cache region, wherein the first cache region is configured for caching the debug bridge data packet.

9. A virtual machine-based data transmission method, comprising:
caching, by a virtual client installed on an intermediate terminal device, a debug bridge service data packet to generate first feedback information, wherein the debug bridge service data packet is received from a target terminal device and is generated using a debug bridge daemon process; and
returning, by the virtual client, the first feedback information to the debug bridge daemon process to send a newly generated debug bridge service data packet,
wherein the debug bridge service data packet is transmitted by the intermediate terminal device to a service terminal device.

10. The method according to claim 9, wherein the virtual client creates a cache region, and the cache region is configured for caching the debug bridge service data packet.

11. The method according to claim 9, wherein after caching, by the virtual client, the debug bridge service data packet, the method further comprises:
converting, by the virtual client, the debug bridge service data packet into a virtual service data packet; and
transmitting, by the virtual client, the virtual service data packet to the service terminal device installed with a virtual host,
wherein after the virtual host obtains the debug bridge service data packet by parsing the virtual service data packet, the debug bridge service data packet is sent, through a virtual storage device pre-created by the virtual host, to a debug bridge executable program of the service terminal device.

12. The method according to claim 11, wherein the debug bridge executable program at least includes: a debug bridge client and a debug bridge service process, and after the debug bridge service data packet is sent to the debug bridge executable program of the service terminal device, the method further comprises:
parsing, by the debug bridge service process of the service terminal device, the debug bridge service data packet;
encapsulating, by the debug bridge service process, the parsed debug bridge service data packet to generate a service-type data packet; and
sending, by the debug bridge service process, the generated service-type data packet to the debug bridge client.

13. A virtual machine-based data transmission system, comprising:
a target terminal device;
a service terminal device, installed with a debug bridge executable program and a virtual host and configured to: after the virtual host receives and caches a debug bridge data packet generated by the debug bridge executable program, convert the debug bridge data packet into a virtual data packet and generate feedback information, and return the feedback information to the debug bridge executable program, such that the debug bridge executable program sends a newly generated debug bridge data packet to the virtual host; and
an intermediate terminal device, installed with a virtual client, connected to the service terminal device through a network and connected to the target terminal device through a storage device, and configured to: receive a debug bridge reply data packet generated, according to the debug bridge data packet, by a debug bridge daemon process of the target terminal device, wherein after the virtual client caches the debug bridge reply data packet and generates feedback reply information, the virtual client returns the feedback reply information to the debug bridge daemon process, such that the debug bridge daemon process send a newly generated debug bridge reply data packet to the virtual client,
wherein the service terminal device transmits the debug bridge data packet to the target terminal device through the intermediate terminal device, and the target terminal device transmits the debug bridge reply data packet to the service terminal device through the intermediate terminal device.

14. A virtual machine-based data transmission apparatus, comprising:
a first receiving module configured to enable a virtual host of a service terminal device to receive the debug bridge data packet through a pre-created virtual storage device, wherein the debug bridge data packet is generated by a debug bridge executable program of the service terminal device;
a processing module configured to enable the virtual host to cache the debug bridge data packet and generate feedback information; and
a first sending module configured to enable the virtual host to return the feedback information to the debug bridge executable program, such that the debug bridge executable program sends a newly generated debug bridge data packet to the virtual host,
wherein the debug bridge data packet is transmitted by the service terminal device to a target terminal device.

15-17. (canceled)

18. A virtual machine-based data transmission apparatus, comprising:
a receiving module configured to enable an intermediate terminal device installed with a virtual client to receive a debug bridge service data packet transmitted by a target terminal device, wherein the target terminal device generates the debug bridge service data packet by using a debug bridge daemon process, and transmits the debug bridge service data packet to the virtual client through a storage device;
a processing module configured to enable the virtual client to cache the debug bridge service data packet and generate first feedback information; and
a first sending module configured to enable the virtual client to return the first feedback information to the debug bridge daemon process to send a newly generated debug bridge service data packet,
wherein the debug bridge service data packet is transmitted by the intermediate terminal device to a service terminal device.

19-20. (canceled)

21. A non-transitory computer readable medium that stores a set of instructions that is executable by at least one processor of an electronic device to cause the device to perform a virtual machine-based data transmission method, the method comprising:
receiving, by a virtual host of the service terminal device, the debug bridge data packet through a pre-created virtual storage device, wherein the debug bridge data packet is generated by a debug bridge executable program of the service terminal device;
caching, by the virtual host, the debug bridge data packet to generate feedback information; and
returning, by the virtual host, the feedback information to the debug bridge executable program, such that the debug bridge executable program sends a newly generated debug bridge data packet to the virtual host,
wherein the debug bridge data packet is transmitted by the service terminal device to a target terminal device.

22. The non-transitory computer readable medium of claim 21, wherein after caching, by the virtual host, the debug bridge data packet, the set of instructions further causes the device to perform:
converting, by the virtual host, the debug bridge data packet into a virtual data packet; and
transmitting, by the virtual host, the virtual data packet to an intermediate terminal device installed with a virtual client,
wherein after the virtual client obtains the debug bridge data packet by parsing the virtual data packet, the debug bridge data packet is sent to the target terminal device through a storage device interface of the intermediate terminal device, and the target terminal device accesses the intermediate terminal device through a storage device.

23. The non-transitory computer readable medium according to claim 22, wherein after the target terminal device receives the debug bridge data packet transmitted by the service terminal device, the set of instructions further causes the device to perform:
generating, by a debug bridge daemon process of the target terminal device, a debug bridge reply data packet according to the debug bridge data packet;
transmitting, by the debug bridge daemon process, the debug bridge reply data packet to the virtual client through the storage device;
caching, by the virtual client, the debug bridge reply data packet to generate feedback reply information; and
returning, by the virtual client, the feedback reply information to the debug bridge daemon process to send a newly generated debug bridge reply data packet.

24-26. (canceled)

27. The non-transitory computer readable medium according to claim 21, wherein the debug bridge executable program at least includes: a debug bridge client and a debug bridge service process, and the set of instructions further causes the device to perform the generation of the debug bridge data packet by:
initiating, by the debug bridge client, a service request to the debug bridge service process;
parsing, by the debug bridge service process, the service request to generate a service data packet; and
encapsulating, by the debug bridge service process, the service data packet according to a debug bridge transmission protocol to generate the debug bridge data packet.

28. (canceled)

29. A non-transitory computer readable medium that stores a set of instructions that is executable by at least one processor of an electronic device to cause the device to perform a virtual machine-based data transmission method, the method comprising:
caching, by a virtual client installed on an intermediate terminal device, a debug bridge service data packet to generate first feedback information, wherein the debug bridge service data packet is received from a target terminal device and is generated using a debug bridge daemon process; and
returning, by the virtual client, the first feedback information to the debug bridge daemon process to send a newly generated debug bridge service data packet,
wherein the debug bridge service data packet is transmitted by the intermediate terminal device to a service terminal device.

30-32. (canceled)
